(19) United States
(12) Patent Application Publication
(10) Pub. No.: US 2024/0394664 A1
(43) Pub. Date: Nov. 28, 2024

(54) SYSTEMS AND METHODS FOR OPTIMIZED APPOINTMENT SCHEDULING AND MANAGEMENT

(71) Applicant: NextUp Care, Newmarket (CA)

(72) Inventor: Wayne Li, Newmarket (CA)

(21) Appl. No.: 18/671,482

(22) Filed: May 22, 2024

Related U.S. Application Data
(60) Provisional application No. 63/468,301, filed on May 23, 2023.

(51) Int. Cl. G06Q 10/109

(52) U.S. Cl. CPC G06Q 10/109

(57) ABSTRACT

Various embodiments for optimized appointment scheduling and management with a provider are disclosed herein. The embodiments disclosed involve operating a processor to receive appointment requests, each appointment request comprising an appointment type and a priority category for the appointment and each priority category associated with a corresponding wait time target. For each appointment request, the processor determines one or more appointment attributes relating to the appointment and provider attributes associated with the appointment, based at least on the appointment request. The processor then calculates an appointment score based on the priority category, the appointment type and the one or more appointment attributes, determines an appointment time based on the appointment score calculated and the provider attributes, and transmits the appointment time to a user device associated with the appointment request. Determining the appointment time comprises maximizing a number of appointment requests having appointment times within the corresponding wait time targets.

### CROSS-REFERENCE TO RELATED APPLICATION

This application claims the benefit of U.S. Provisional Patent Application No. 63/468,301 filed May 23, 2023, and the entire content of U.S. Provisional Patent Application No. 63/468,301 is hereby incorporated herein in its entirety.

### FIELD

The embodiments described herein generally relate to systems and methods for automatically and optimized scheduling and management of appointments.

### BACKGROUND

The following is not an admission that anything discussed below is part of the prior art or part of the common general knowledge of a person skilled in the art.

Typically, appointments are scheduled manually by clerks or schedulers who query a calendar to find the next vacant time slot and manually communicate with individuals for which appointments are scheduled. When a large number of services are provided by a provider, this process can additionally involve finding the appropriate calendar(s) for the services requested before searching the calendar(s) for available time slots. This process is time consuming and costly, often requiring several minutes for each appointment request received. When a change request such as a cancellation or a rescheduling request is received, the calendar querying process and the communication process are repeated, making the scheduling process even more time consuming.

In situations where a large number of appointment requests need to be processed, manual scheduling and rescheduling can result in significant backlogs, causing dissatisfaction and can cause appointment providers to fail to meet targets. Additionally, manual scheduling and rescheduling often results in inefficient appointment schedules, leading to long wait times and inefficient use of resources.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least embodiment, there is provided a system for scheduling appointments with a provider. The system comprises: a database for storing provider attributes; and a processor in communication with the database. The processor is operable to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment and a plurality of provider attributes associated with the appointment, based at least on the appointment request; calculate an appointment score based on the priority category, the appointment type and the one or more appointment attributes relating to the appointment; determine an appointment time based on the appointment score calculated and the plurality of provider attributes; and transmit the appointment time to a user device associated with the appointment request, wherein determining the appointment time comprises maximizing a number of appointment requests having appointment times within the corresponding wait time targets

In some embodiments, the processor is further operable to determine the appointment time based on one or more of the following factors: the priority category of the appointment request, the appointment type of the appointment request, an appointment receive date of the appointment request.

In some embodiments, each of the factors, the appointment score and the provider attributes are ranked and wherein the processor is operable to determine the appointment time according to the ranking.

In some embodiments, the processor is operable to search a provider schedule of the provider to determine the appointment time for each appointment request.

In some embodiments, the processor is further operable to: determine that one or more appointment times exceed the wait time target of a corresponding one or more appointment requests; generate one or more waitlist comprising the corresponding one or more appointment requests; receive an appointment cancellation request associated with an appointment; and in response to receiving the appointment cancellation request, assigning the appointment time of the appointment to an appointment request selected from one of the one or more waitlist so that the appointment time for the appointment request is within the corresponding wait time target.

In some embodiments, each of the one or more waitlist is a ranked waitlist according to one of: the appointment score of each of the one or more appointment request and a corresponding wait time of each of the one or more appointment request.

In some embodiments, each of the one or more waitlist is associated with one of an appointment type or appointment attributes.

In some embodiments, the appointment type of the appointment request selected and the appointment type of the appointment associated with the appointment cancellation request are of a same type.

In some embodiments, determining the appointment time comprises determining the appointment time for two or more appointment requests at a predetermined time interval.

In some embodiments, determining the appointment time comprises assigning consecutive appointment times to two or more appointment requests associated with a same appointment type.

In some embodiments, determining the appointment time further comprises maximizing a number of appointments within a predefined time window.

In some embodiments, determining the appointment time further comprises minimizing an unused time of a predetermined time slot.

In some embodiments, determining the appointment is based on a relative importance of the appointment score calculated and each of the provider attributes.

In some embodiments, for each of the appointment requests the processor is operable to: monitor for an appointment confirmation from the user device in response to the appointment time transmitted to the user device; and if the appointment confirmation is not received within a predetermined time period, assign the appointment time to one or more other appointment requests.

In some embodiments, the processor is further operable to: determine that assigning the appointment time of a first appointment request to a second appointment request causes a reduction in a combined wait time; and reassign the appointment time of the first appointment request to the second appointment request.

In some embodiments, the second appointment request is selected based on the appointment score of each of the first appointment request and the second appointment request.

In some embodiments, the processor is further operable to: assign priority points to the first appointment request; calculate a revised appointment score for the first appointment request based on the priority points; and determine a revised appointment time for the first appointment request, wherein determining the revised appointment time is based on the revised appointment score of the first appointment request and the provider attributes.

In some embodiments, the processor is further operable to: determine that the appointment time of associated with an appointment request exceeds the wait time target of the appointment request by a threshold wait time; and in response to determining that the appointment time exceeds the wait time target, determine a revised appointment time for the appointment request, wherein the revised appointment time reduces a wait time associated with the appointment request.

In some embodiments, the processor is further operable to: determine that modifying the appointment time of one or more appointment requests causes a reduction in a combined wait time; determining a revised appointment time for one or more of the one or more appointment requests, wherein the revised appointment time reduces the combined wait time.

In some embodiments, for each of the appointment requests, the processor is further operable to: identify a user profile associated with the appointment request; determine appointment preferences for the appointment based on the user profile; and determine the appointment time based on the appointment preferences.

In some embodiments, the processor is further operable to: determine one or more user attributes based on the user profile; and determine the appointment time based on the one or more user attributes.

In some embodiments, the one or more attributes comprise one or more of: an age of the individual, a disability status of the individual, a type of disability of the individual and a medical condition of the individual.

In some embodiments, the one or more appointment attributes comprise one or more of: a patient status, a referral order receive date, and a machine required for the appointment.

In some embodiments, the plurality of provider attributes comprise two or more of: operating times of the provider, predefined times for the appointment type, predefined times for priority categories, predefined times for the appointment attributes, preferences relating to a machine required for the appointment, personnel required for the appointment, a duration of the appointment based on the machine required for the appointment, policies relating to the appointment type and a relative importance of the provider attributes.

In some embodiments, the priority category for the appointment is one of a first priority category associated with a first wait time target, a second priority category associate with a second wait time target, a third priority category associated with a third wait time target and a fourth priority category associated with a fourth wait time target, where the fourth wait time target corresponds to a time period longer than the third wait time target, the third wait time target corresponds to a time period longer than the second wait time target, and the second wait time target corresponds to a time period longer than the first wait time target.

In some embodiments, the priority category for the appointment is one of a first priority category associated with a wait time target of 24 hours, a second priority category associate with a wait time target of 48 hours, a third priority category associated with a wait time target of 10 days and a fourth priority category associated with a wait time target of 28 days.

In some embodiments, the priority category for the appointment is one of two or more priority categories.

In some embodiments, each of the two or more priority categories is associated with a different wait time target.

In accordance with another aspect, in at least one embodiment, there is provided a method for scheduling appointments with a provider. The method comprises operating a processor to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment and a plurality of provider attributes associated with the appointment, based at least on the appointment request; calculate an appointment score based on the priority category, the appointment type and the one or more appointment attributes relating to the appointment; determine an appointment time based on the appointment score calculated and the plurality of provider attributes; and transmit the appointment time to a user device associated with the appointment request, wherein determining the appointment time comprises maximizing a number of appointment requests having appointment times within the corresponding wait time targets.

In some embodiments, the method further comprises operating the processor to determine the appointment time based on one or more of the following factors: the priority category of the appointment request, the appointment type of the appointment request, an appointment receive date of the appointment request.

In some embodiments, each of the factors, the appointment score and the provider attributes are ranked and wherein the processor is operable to determine the appointment time according to the ranking.

In some embodiments, the method further comprises operating the processor to search a provider schedule of the provider to determine the appointment time for each appointment request.

In some embodiments, the method further comprises operating the processor to determine that one or more appointment times exceed the wait time target of a corresponding one or more appointment requests; generate one or more waitlist comprising the corresponding one or more appointment requests; receive an appointment cancellation request associated with an appointment; and in response to receiving the appointment cancellation request, assigning the appointment time of the appointment to an appointment request selected from one of the one or more waitlist so that the appointment time for the appointment request is within the corresponding wait time target.

In some embodiments, each of the one or more waitlist is a ranked waitlist according to one of: the appointment score of each of the one or more appointment request and a corresponding wait time of each of the one or more appointment request.

In some embodiments, each of the one or more waitlist is associated with one of an appointment type or appointment attributes.

In some embodiments, the appointment type of the appointment request selected and the appointment type of the appointment associated with the appointment cancellation request are of a same type.

In some embodiments, determining the appointment time comprises operating the processor to determine the appointment time for two or more appointment requests at a predetermined time interval.

In some embodiments, determining the appointment time comprises operating the processor to assign consecutive appointment times to two or more appointment requests associated with a same appointment type.

In some embodiments, determining the appointment time further comprises maximizing a number of appointments within a predefined time window.

In some embodiments, determining the appointment time further comprises minimizing an unused time of a predetermined time slot.

In some embodiments, wherein determining the appointment is based on a relative importance of the appointment score calculated and each of the provider attributes.

In some embodiments, for each of the appointment requests the processor is operable to: monitor for an appointment confirmation from the user device in response to the appointment time transmitted to the user device; and if the appointment confirmation is not received within a predetermined time period, assign the appointment time to one or more other appointment requests.

In some embodiments, the method further comprises operating the processor to: determine that assigning the appointment time of a first appointment request to a second appointment request causes a reduction in a combined wait time; and reassign the appointment time of the first appointment request to the second appointment request.

In some embodiments, the second appointment request is selected based on the appointment score of each of the first appointment request and the second appointment request.

In some embodiments, the method further comprises operating the processor to assign priority points to the first appointment request; calculate a revised appointment score for the first appointment request based on the priority points; determine a revised appointment time for the first appointment request; and determine the revised appointment time based on the revised appointment score of the first appointment request and the provider attributes.

In some embodiments, the method further comprises operating the processor to determine that the appointment time of associated with an appointment request exceeds the wait time target of the appointment request by a threshold wait time; and in response to determining that the appointment time exceeds the wait time target, determine a revised appointment time for the appointment request, wherein the revised appointment time reduces a wait time associated with the appointment request.

In some embodiments, the method further comprises operating the processor to determine that modifying the appointment time of one or more appointment requests causes a reduction in a combined wait time; determining a revised appointment time for one or more of the one or more appointment requests, wherein the revised appointment time reduces the combined wait time.

In some embodiments, the method further comprises operating the processor to identify a user profile associated with the appointment request; determine appointment preferences for the appointment based on the user profile; and determine the appointment time based on the appointment preferences.

In some embodiments, the method further comprises operating the processor to determine one or more user attributes based on the user profile; and determine the appointment time based on the one or more user attributes.

In some embodiments, the one or more attributes comprise one or more of: an age of the individual, a disability status of the individual, a type of disability of the individual and a medical condition of the individual.

In some embodiments, the one or more appointment attributes comprise one or more of: a patient status, a referral order receive date, and a machine required for the appointment.

In some embodiments, the plurality of provider attributes comprise two or more of: operating times of the provider, predefined times for the appointment type, predefined times for priority categories, predefined times for the appointment attributes, preferences relating to a machine required for the appointment, personnel required for the appointment, a duration of the appointment based on the machine required for the appointment, policies relating to the appointment type and a relative importance of the provider attributes.

In some embodiments, the priority category for the appointment is one of a first priority category associated with a first wait time target, a second priority category associate with a second wait time target, a third priority category associated with a third wait time target and a fourth priority category associated with a fourth wait time target, where the fourth wait time target corresponds to a time period longer than the third wait time target, the third wait time target corresponds to a time period longer than the second wait time target, and the second wait time target corresponds to a time period longer than the first wait time target.

In some embodiments, the priority category for the appointment is one of a first priority category associated with a wait time target of 24 hours, a second priority category associate with a wait time target of 48 hours, a third priority category associated with a wait time target of 10 days and a fourth priority category associated with a wait time target of 28 days.

In some embodiments, the priority category for the appointment is one of two or more priority categories.

In some embodiments, each of the two or more priority categories is associated with a different wait time target.

In another aspect, in at least one embodiment, there is provided a system for scheduling appointments with a provider within a network of two or more providers. The system comprises: a database for storing provider attributes associated with each of the providers; and a processor in communication with the database. The processor is operable to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment; for each of the providers, determine a plurality of provider attributes associated with the appointment based at least on the appointment request; calculate an appointment score based on the priority category, the appointment type and one or more attributes relating to the appointment; determine an appointment time and the provider for the appointment based on the appointment score calculated and the plurality of provider attributes of each of the providers; and transmit the appointment time and the provider to a user device associated with the appointment request, wherein determining the appointment time comprises maximizing a number of appointment times within the wait time target of corresponding appointment requests.

In some embodiments, for each of the appointment request, the processor is further operable to: identify a user profile associated with the appointment request; determine appointment preferences for the appointment based on the user profile, the appointment preferences comprising preferences relating to the two or more providers; and determine the appointment time based on the appointment preferences.

In another aspect, in at least one embodiment, there is provided a method for scheduling appointments with a provider within a network of two or more providers. The method comprises operating a processor to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment; for each of the providers, determine a plurality of provider attributes associated with the appointment based at least on the appointment request; calculate an appointment score based on the priority category, the appointment type and one or more attributes relating to the appointment; determine an appointment time and the provider for the appointment based on the appointment score calculated and the plurality of provider attributes of each of the providers; and transmit the appointment time and the provider to a user device associated with the appointment request, wherein determining the appointment time comprises maximizing a number of appointment times within the wait time target of corresponding appointment requests.

In some embodiments, the method further comprises operating the processor to: identify a user profile associated with the appointment request; determine appointment preferences for the appointment based on the user profile, the appointment preferences comprising preferences relating to the two or more providers; and determine the appointment time based on the appointment preferences.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an example scheduling system in communication with a provider in accordance with an embodiment;

FIG. 2 is a block diagram of the example scheduling system of FIG. 1 in communication with external components;

FIG. 3A is a flowchart of an example method for scheduling appointments in accordance with an embodiment;

FIG. 3B is a flowchart of an example method for scheduling appointments in accordance with another embodiment;

FIG. 3C is a flowchart of an example method for scheduling appointments in accordance with another embodiment;

FIG. 4A is a screenshot of a simplified example appointment schedule determined by the scheduling system of FIG. 1;

FIG. 4B is another a screenshot of a simplified example appointment schedule determined by the scheduling system of FIG. 1;

FIG. 5 is another screenshot of a simplified example appointment schedule determined by the scheduling system of FIG. 1;

FIG. 6 is a screenshot of an example graphical user interface (GUI) showing an appointment confirmation in accordance with an embodiment;

FIG. 7 is a screenshot of an example GUI showing an appointment confirmation in accordance with an embodiment;

FIG. 8A is a table showing waiting times associated with rescheduling appointments according to an example embodiment;

FIG. 8B is a calendar showing appointment schedules for a first and second appointment request according to an example embodiment;

FIG. 8C is a calendar showing revised appointment schedules for a first and second appointment request according to an example embodiment;

FIG. 9A is a screenshot of an example GUI showing an appointment rescheduling notification in accordance with an embodiment;

FIG. 9B is a screenshot of an example GUI showing an appointment rescheduling notification in accordance with an embodiment;

FIG. 10 is a block diagram of an example scheduling system in communication with multiple providers in accordance with an embodiment;

FIG. 11 is a block diagram of an example provider network with which the scheduling system of FIG. 10 can communicate;

FIG. 12 is a flowchart of an example method for scheduling appointments in accordance with an embodiment; and

FIG. 13 is a screenshot of an example GUI showing an appointment confirmation in accordance with an embodiment.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more elements are said to be “coupled”, “connected”, “attached”, or “fastened” where the parts are joined or operate together either directly or indirectly (i.e., through one or more intermediate parts), so long as a link occurs. As used herein and in the claims, two or more elements are said to be “directly coupled”, “directly connected”, “directly attached”, or “directly fastened” where the element are connected in physical contact with each other. None of the terms “coupled”, “connected”, “attached”, and “fastened” distinguish the manner in which two or more elements are joined together.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Conventionally, appointment requests received by a provider are scheduled manually by booking clerks or schedulers, by querying the appointment provider's calendar(s) and finding the next available time slot. This time slot is then manually communicated to the individual requesting the appointment. This process is time consuming and costly, particularly when a large number of appointment requests need to be processed and/or a large number of services is offered by the provider. The time and cost associated with scheduling appointments further increases when appointments are cancelled and/or need to be rescheduled, whether by the provider or the individual requesting the appointment.

As the number of appointments that must be processed by booking clerks increases, the number of relevant variables that must be considered to generate a schedule that maximizes throughput and minimizes wait times and the time required to evaluate these variables becomes too great. This inability to manually consider all relevant variables results in inefficient appointment schedules, leading to long wait times, inefficient use of resources which often causes frustration amongst all actors involved in the scheduling process. The time consuming and the labor intensive nature of the scheduling process is further exacerbated when appointments are cancelled or rescheduled. In medical contexts, inefficient appointment schedules can cause a hospital to fail to meet its targets (e.g., governmental targets), which can affect the funding received by the hospital. In some cases, excess waiting times caused by inefficient appointment schedules can also cause treatment delays, which in turn can lead to negative patient outcomes.

To maximize throughput and minimize wait times, embodiments described herein disclose systems and methods for automatically scheduling appointments with providers. The disclosed embodiments can relate to scheduling medical appointments and can be used by medical service providers such as hospitals and medical clinics to automatically schedule medical appointments for patients. The disclosed embodiments can be integrated into existing systems for receiving requests to schedule appointments and/or existing systems for recording appointments (e.g., calendar systems). As will be described in detail below, the disclosed systems and methods receive appointment requests to schedule appointments, each appointment request including an appointment type and a priority category associated with a wait time target defining an ideal maximum wait time between the reception time of the appointment request and the appointment time. To automatically schedule appointments, the disclosed systems and methods determine appointment attributes defining characteristics of each appointment and provider attributes defining characteristics of the provider for each appointment, and calculate an appointment score for each appointment request received, based at least in part on the priority category of each appointment request. The disclosed systems and methods subsequently determine appointment times based at least on the appointment score and the provider attributes. When determining appointment times, the embodiments described herein can schedule appointments so that a maximum number of the appointments are scheduled within their corresponding wait time targets. By determining appointment times based on appointment scores and provider attributes, the embodiments described herein can prioritize scheduling some appointments over others, increasing efficiency and ensuring that time-sensitive appointments are scheduled in a timely manner. By determining provider attributes and identifying resources available, the disclosed systems and methods can increase utilization of resources, minimizing down-time.

At least some of the embodiments described herein can additionally automatically fill cancellation slots (i.e. time slots associated with cancelled appointments) and/or proactively reschedule appointments so that wait times are reduced and/or so that resource utilization is maximized. The embodiments described herein can continuously monitor appointment schedules to identify changes that can increase throughput and minimize wait times.

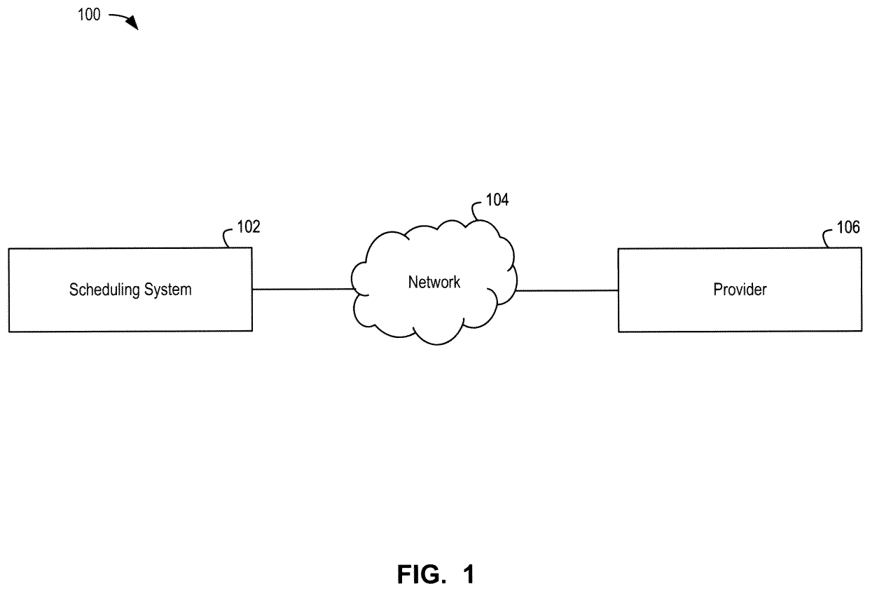

Reference is first made to FIG. 1, which shows a block diagram 100 of a scheduling system 102 in communication with a provider 106 via a network 104.

The scheduling system 102 receives appointment requests from individuals requiring appointments and/or from referring individuals requesting an appointment on behalf of other individuals and schedules appointments with the provider 106. In some cases, the scheduling system 102 can be integrated within a booking system used by the provider 106 to receive, schedule and/or record appointments.

In scheduling appointments, the scheduling system 102 can increase the efficiency of the provider 106 by optimizing the appointment schedule(s) of the provider 106 so that wait times associated with appointments are minimized, provider resource utilization is maximized and/or the number of appointments scheduled within a given time window is maximized.

The provider 106 can be an entity or an individual providing services that can be scheduled. For example, the provider 106 can be a hospital, or a medical clinic providing medical services.

The network 104 may be any network that allows the scheduling system 102 to communicate with the provider 106. The network 104 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WiFi, WiMAX), SS7 signaling network, fixed line, local area network, wide area network, and others, including any combination of these, capable of interfacing with, and enabling communication between, the scheduling system 102 and the provider 106.

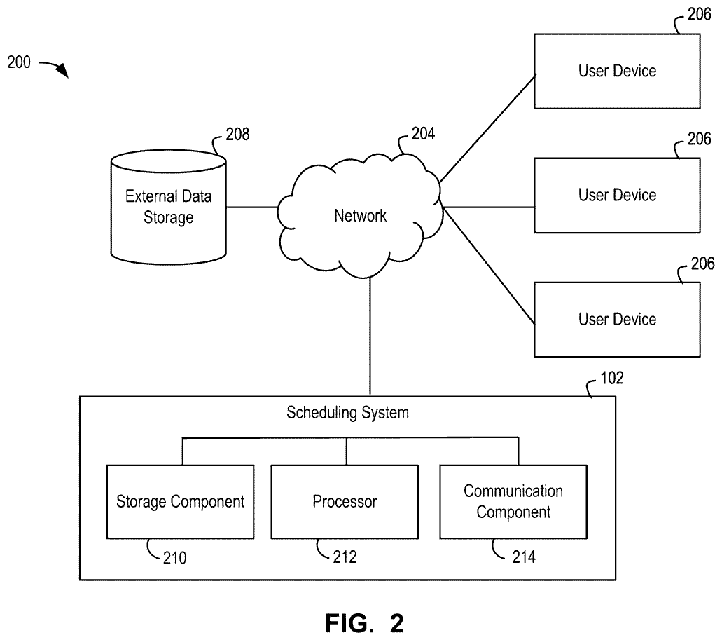

Referring now to FIG. 2, there is shown a block diagram of the scheduling system 102, in communication with an external data storage 208 and user devices 206, via a network 104. While FIG. 2 shows three user devices 206, it will be understood that the scheduling system 202 may be in communication with a greater number of user devices. The scheduling system 102 can communicate with the user devices 206 over a wide geographic area via the network 204.

As shown in the example of FIG. 2, the scheduling system 102 includes a storage component 210, a processor 212 and a communication component 214. The scheduling system 102 can be implemented with more than one computer server distributed over a wide geographic area and connected via the network 204 and may be provided using various computing such as, for example, an electronic tablet device, a personal computer, workstation, server, portable computer, mobile device, personal digital assistant, laptop, smart phone, WAP phone, an interactive television, video display terminals, gaming consoles, and portable electronic devices etc. The storage component 210, the processor 212 and the communication component 214 may be combined into a fewer number of components or may be separated into further components.

The processor 212 can be implemented with any suitable processors, controllers, digital signal processors, application specific integrated circuits (ASICs), and/or field programmable gate arrays (FPGAs) that can provide sufficient processing power depending on the configuration, purposes and requirements of the scheduling system 102. In some embodiments, the processor 212 can include more than one processor with each processor 212 being configured to perform different dedicated tasks.

The processor 212 can be configured to control the operation of the scheduling system 102. For example, the processor 212 can receive appointment requests and schedule appointments. The processor 212 can also be configured to control communications between the scheduling system 212, the external data storage 208 and the user devices 206.

The communication component 214 may be any component that enables the scheduling system 202 to communicate with other devices and systems, such as, but not limited to, the user devices 206 and the external data storage 208. For example, the communication component can receive appointment requests that may then be transmitted to the processor 212 and can transmit appointment confirmations to the user devices 206. In some embodiments, the communication component 214 can include at least one of a serial port, a parallel port or a USB port. The communication interface 214 may also include at least one of an Internet, Local Area Network (LAN), Ethernet, Firewire, modem or digital subscriber line connection. In some embodiments, the communication component 214 may be a wireless communication interface, which can transmit various data to other devices or systems via Bluetooth, WiFi, or other suitable wireless communication standard. Various combinations of these elements may be incorporated within the communication component 214. For example, the communication component 214 may receive input from various input devices, such as a mouse, a keyboard, a touch screen, a thumbwheel, a trackpad, a track-ball, a card-reader, voice recognition software and the like depending on the requirements and implementation of the scheduling system 102.

The storage component 210 can include RAM, ROM, one or more hard drives, one or more flash drives or some other suitable data storage elements such as disk drives, etc. The storage component 210 can include one or more databases for storing data, such as, but not limited to data relating to provider attributes, data relating to appointment attributes and user profiles, including data related to user preferences and user attributes. The storage component 210 can additionally store algorithms and computer-executable instructions that can be executed by the processor 212 to schedule appointments.

The external data storage 208 can store data similar to that of the storage component 210. The external data storage 208 can, in some embodiments, be used to store data that is less frequently used and/or older data. In some embodiments, the external data storage 208 can be a third-party data storage stored with input data for analysis by the scheduling system 102. The data stored in the external data storage 208 can be retrieved by the scheduling system 102 via the network 204.

Each user device 206 can be any device capable of communicating with other devices through a network such as the network 204. Each user device 206 can couple to the network 204 through a wired or wireless connection. Each user device 206 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Each user device 206 can be associated with a user of the scheduling system 102, such as, for example, an individual for which an appointment is to be scheduled, and can be configured to receive appointment confirmations. In some embodiments, the user devices 206 can transmit appointment requests to the scheduling system 102. In some embodiments, some user devices 206 can be referral user devices and can be associated with entities or individuals requesting or referring an appointment on behalf of the individual receiving the appointment. In such embodiments, the scheduling system 102 can receive appointment requests from referral user devices and can transmit appointment confirmations to user devices 206 associated with the individual for which the appointment is scheduled.

The network 204 may be substantially similar to the network 104 and can be capable of interfacing with, and enabling communication between, the scheduling system 202, the user devices 206 and the external data storage 208.

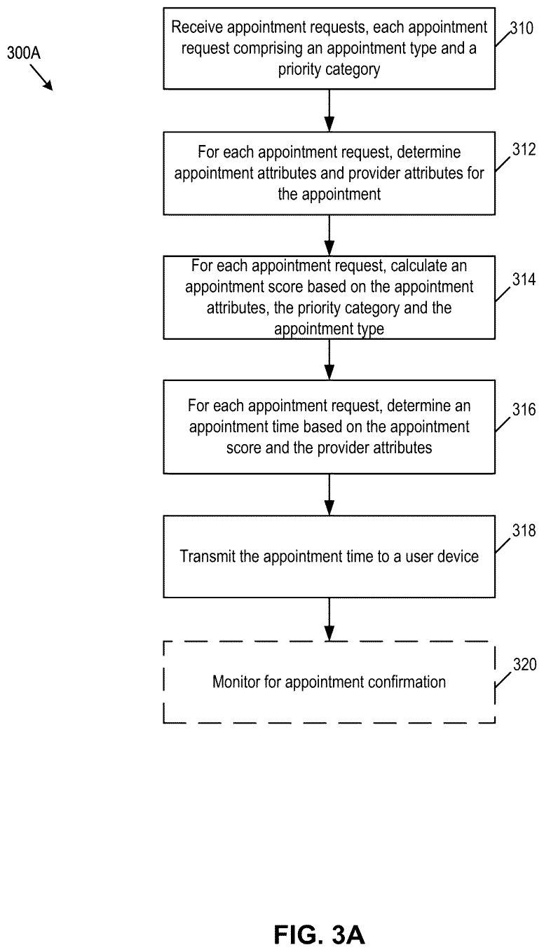

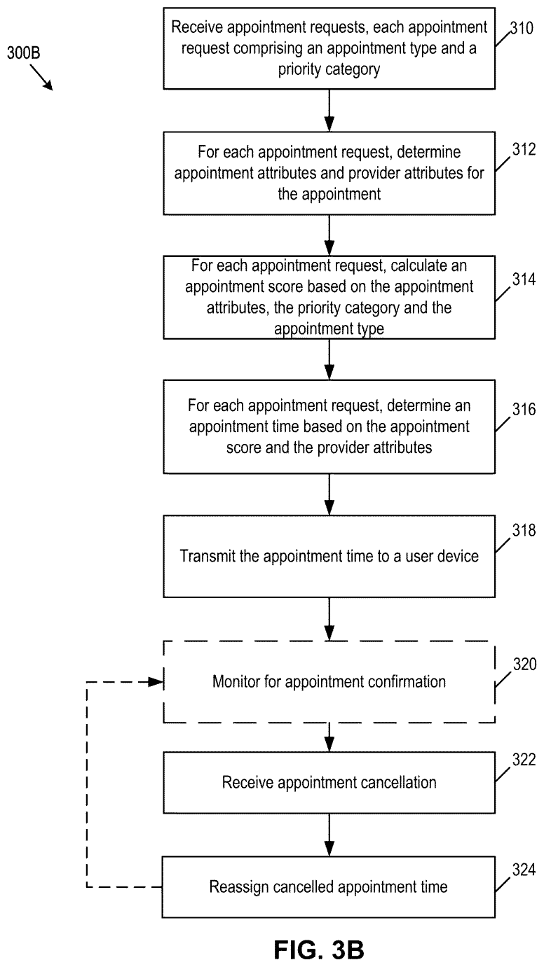

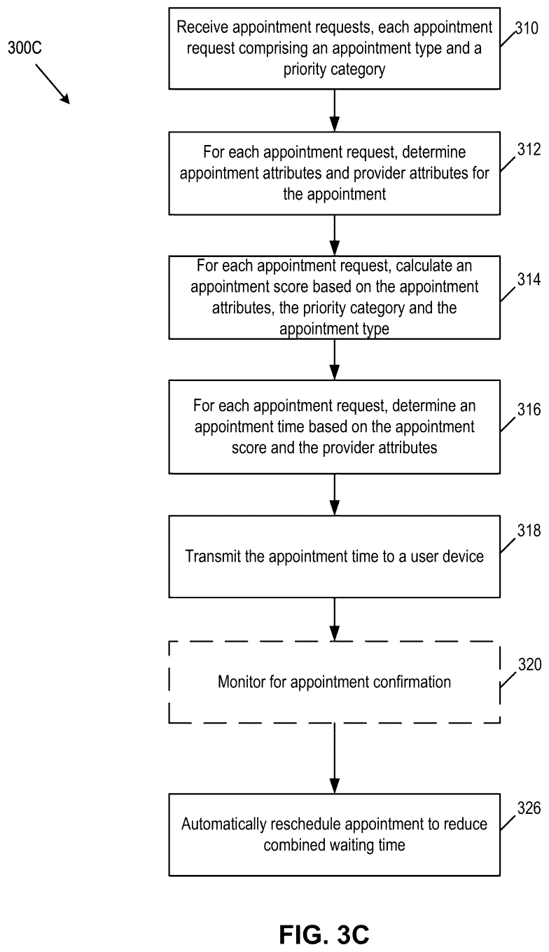

Referring now to FIG. 3, there is shown a flowchart of an example method 300 for scheduling appointments with a provider which may be implemented by the scheduling system 102 described herein.

At 310, the processor 212 receives appointment requests. The appointment requests can be transmitted, for example, from user devices 206, including referral user devices 206. Each appointment request can be associated with an individual associated with a user device 206. Each appointment request includes an appointment type and a priority category for the appointment. In a medical setting, the appointment type can correspond to, for example, a type of procedure or test (e.g., medical imaging, biopsy, treatment procedure, physical examination, etc.) and can include information relating to the body part for which the appointment is requested (e.g., spinal examination, thoracic examination, brain examination, etc.).

Each priority category is associated with a wait time target corresponding to an ideal maximum wait time between the time at which the appointment request is received and the time at which the appointment occurs and can be indicative of the time-sensitivity of the appointment. For example, in an embodiment including four priority categories, a first priority category (P1) can be associated with a wait time target of 24 hours; a second priority category (P2) can be associated with a wait time target of 48 hours; a third priority category (P3) can be associated with a wait time target of 10 days; and a fourth priority category (P4) can be associated with a wait time target of 28 days. The number of priority categories and the wait time targets associated with each of the priority categories can vary depending on the implementation of the scheduling system 102, the provider, governmental policies or any combination thereof.

At 312, the processor 212 determines, for each appointment request received at 310, appointment attribute(s) relating to the appointment and provider attribute(s) associated with the appointment. In various embodiments described herein, the appointment attribute(s) and provider attribute(s) are determined based on the appointment request. In some embodiments, in addition to the appointment type and the priority category, the appointment request includes at least some appointment attributes. Alternatively, or in addition thereto, the processor 212 can determine at least some appointment attributes based on the appointment type and/or the priority category of the appointment request. For example, some appointment types and/or priority categories can be associated with specific appointment attributes.

Appointment attributes correspond to characteristics that define an appointment or that can affect the relative priority of an appointment request. For example, in a medical setting, appointment attributes can include, but are not limited to a patient status (e.g., inpatient, outpatient, emergency), appointment request receive date (e.g., referral order receive date) and a machine or technology required for the appointment (e.g., magnetic resonance imaging (MRI), computerized axial tomography (CAT), ultrasound, etc.). The referral order receive date can correspond to the date from which the wait time is calculated. For example, a wait time target of 10 days can indicate that an appointment should optimally be scheduled within 10 days of the referral order receive date. In some embodiments, appointment attributes can additionally include a duration of an appointment based on the appointment type.

Provider attributes correspond to characteristics of the provider which affect the availability of appointments, including, resources available, scheduling constraints and policies and provider preferences. In a medical setting, provider attributes can include, but are not limited to, operating times of the provider, dedicated predefined times for certain types of appointments, dedicated predefined times for certain priority categories, dedicated predefined times for certain appointment attributes, provider preferences relating to a machine required for an appointment, personnel/operators required for an appointment, duration of an appointment based on a machine required for the appointment, policies relating to the appointment type and a relative importance of provider attributes (i.e., a ranking of provider attributes). For example, predefined times can correspond to time windows in a schedule dedicated to certain types of appointments, certain priority categories and/or certain appointment attributes due to limited availability of personnel, the equipment required and/or provider policies. A provider may, for example, have a policy to schedule certain appointment types during certain times of the day, only on specific days or only in blocks of similar appointments. Preferences relating to a machine can correspond to a provider preference to use a specific type of machine or a specific machine for certain types of appointments, over other machines having similar or the same functionalities. The duration of an appointment can vary based on the specific machine used for the appointment. Operating times of the provider can include times during which appointments are not to be scheduled due to, for example, a machine or appointment room being scheduled for maintenance or personnel being unavailable to attend to the appointment.

As described, in various embodiments described herein, the provider attributes are determined based on the appointment request. In various embodiments, the provider attributes can be determined with reference to the appointment type and/or the priority category of the appointment request and in some embodiments, based on appointment attributes. For example, depending on the type of appointment of an appointment request or the priority category of an appointment request, different predefined time slots may be determined. As another example, based on the machine required for an appointment, the processor 112 can determine that a trained operator is needed and determine times during which a trained operator is available.

At 314, for each appointment request, the processor 212 calculates an appointment score for the appointment. In various embodiments disclosed herein, the appointment score is based on the priority category, the appointment type and the appointment attribute(s). For example, each priority category, each appointment type and at least some of the appointment attributes can be associated with a number of points. The number of points assigned to a priority category, an appointment type or an appointment attribute can be indicative of the relative importance or priority of the appointment request. An appointment request associated with a high priority category may, for example, be allocated a higher number of points than an appointment request associated with a low priority category appointment request. In some embodiments, appointment requests may additionally be assigned additional points (priority points) by the provider, to indicate that the appointment request should be prioritized by the scheduling system 202. For example, an appointment request associated with an appointment previously cancelled by the provider may be assigned additional priority points. In some embodiments, points may be subtracted from the calculated appointment score of an appointment request to indicate that the appointment request should be given less priority relative to other, similar appointment requests. For example, if multiple rescheduling requests are received for the same appointment request within a predetermined timeframe, the processor 212 may subtract points from the calculated appointment score. In some embodiments, a user profile associated with the individual associated with the rescheduling requests may be updated to indicate that multiple rescheduling requests have been received within the predetermined timeframe. When subsequent appointment requests are received from or for the same individual, the priority category of the subsequent appointment requests may be changed to a lower priority category and/or the calculated appointment scores of the subsequent appointment requests may be adjusted so that the subsequent appointment requests are given less priority relative to other, similar appointments.

At 316, for each appointment request, the processor 212 determines an appointment time for the appointment. In some embodiments, the provider schedule or portions of the provider schedule are divided into predefined time slots of predefined duration and determining an appointment time involves identifying an available time slot from the predefined time slots. In other embodiments, the provider schedule is not divided into predefined time slots and determining an appointment time involves determining a time slot in the provider schedule that does not overlap with another appointment, without reference to predefined time slots. The appointment time is determined based on the calculated appointment score and the provider attributes. For example, the processor 212 can determine appointment times based on the appointment score and according to the available resources, scheduling constraints and/or policies and preferences of the provider.

In various embodiments, when determining appointment times, the processor 212 prioritizes appointment requests associated with the highest number of points. Since appointment scores are based in part on the priority category of appointment requests, in most cases, in determining appointment times for appointment requests, the processor 212 prioritizes assigning time slots to appointment requests associated with a high priority category over appointment requests associated with a low priority category. In some cases, however, a low priority category appointment request may be associated with a higher number of points than a higher priority category (e.g., due to added priority points) as will be described in further detail below. In such cases, the low priority category appointment request may be prioritized by the processor 212.

In various embodiments, the appointment time is determined such that a maximum number of appointment requests are scheduled within their respective wait time targets. In some embodiments, determining appointment times involves maximizing resource utilization. Maximizing resource utilization can involve maximizing the number of appointments scheduled within a time window and minimizing down-time and/or idle time within a time window.

In some embodiments, appointment times are additionally determined based in part on the priority category of the appointment requests. For example, the processor 212 can search the provider schedule for availabilities, starting on a certain day (search date), depending on the priority category of the appointment request. For a high priority category appointment request for example, the processor 212 may search the provider schedule for availabilities starting on the day the appointment request is received while for a low priority category appointment request, the processor 212 may search the provider schedule for availabilities starting a predetermined number of days after the appointment request is received (such as, for example, 7 days, 10 days, 14 days, 28 days, etc. after the appointment request is received). The search date searched by the processor 212 can correspond to the wait time target of the appointment request for which an appointment time is determined. For example, for an appointment request associated with a wait time target of 10 days, the processor 212 may search the provider schedule for availabilities starting 10 days after the appointment request is received. Starting from the search date, the processor 212 may search for availabilities occurring before the search date and preferentially assign one such time slot to the appointment request. In some embodiments, the processor 212 only searches for availabilities occurring on or after the search date if no time slots prior to the search date are available. As another example, the processor 212 can prioritize scheduling appointments based on their relative priority, as determined by their priority category. As another example, the processor 212 assigns consecutive time slots to appointments sharing a priority category, as will be described in further detail below.

In some embodiments, appointment times are additionally determined based in part on the appointment type of the appointment requests. For example, the processor 212 can prioritize scheduling some types of appointments. The types of appointments prioritized may vary depending on the implementation of the scheduling system 102 and on the provider 106. As another example, the processor 212 can assign consecutive time slots to appointments of the same type, as will be described in further detail below.

In some embodiments, appointment times are additionally determined based in part on appointment request receive date. The processor 212 can determine appointment times for appointment requests based on the order in which the appointment requests are received. For example, if two near identical or similar appointment requests are received, the processor 212 can prioritize scheduling the earlier received appointment, such that waiting time is minimized.

As described, the provider attributes can also include information about a relative importance or weightage of each attribute. In determining an appointment time for an appointment, the processor 212 can prioritize provider attributes which have a higher relative weight. In an example embodiment, a provider attribute of predefined time slots can be assigned a higher relative priority than the provider attribute of provider machine preferences. As described, the provider attribute of predefined time slots defines time slots dedicated to certain types of appointments, certain priority categories, and/or certain appointment attributes and the provider attribute of provider machine preferences defines a provider's preferences to use a specific type of machine or a specific machine for certain types of appointments. In this example embodiment, the processor 212 may for example, assign an appointment to a machine which does not correspond to the preferred machine for the appointment type in order to prioritize scheduling the appointment within a predefined time slot for the appointment type. The relative ranking of provider attributes may vary depending on the implementation of the scheduling system 202 and/or may be determined by the provider.

In some embodiments, each of the factors described above are assigned a relative priority and the processor 212 determines appointment times in accordance with the relative priority of each factor. For example, the factors may be ranked in the following order: (1) priority category of the appointment request; (2) predefined time slots; (3) appointment type of the appointment request; (4) provider machine preferences; (5) duration of the appointment; (6) appointment score associated with the appointment request; (7) appointment request receive date. In this example, in determining appointment times, the processor 212 prioritizes determining appointment times for appointment requests associated with a high priority category, and assigning appointment requests to predefined time slots and may not schedule appointments in the order in which they are received if the factors having a higher ranking cannot be accommodated. In this example, a higher priority appointment may also be scheduled within a time slot allocated for lower priority appointments. The ranking can vary depending on the implementation of the scheduling system 102 and the provider.

The processor 212 can determine appointment times for at least some appointments as the appointment requests are received, in real-time. Alternatively, or in addition thereto, the processor 212 can determine appointment times for at least some appointment request in “batches”. For example, the processor 212 can collect appointment requests until a threshold is reached and determine appointment times for all appointment requests received. The threshold can be time-based (i.e., predetermined window of time) or can be based on the number of appointments received. For example, the processor 212 may determine appointment times for appointment requests when a threshold number of appointment requests have been received. In embodiments where the threshold is time-based, the frequency at which appointment requests are processed can vary depending on the implementation of the scheduling system 102 and/or on the requirements of the provider 106. In some embodiments, at least some priority categories are associated with real-time scheduling while other priority categories are associated with “batch booking”. For example, in an embodiment including four priority categories, a first and second priority categories, corresponding to high priority categories can be associated with real-time scheduling and a third and fourth priority categories can be associated with batch-booking. In some embodiments, the number of appointments received by the scheduling system 102 determines how appointment requests are processed. For example, in cases where relatively few appointment requests are received, it may be advantageous to schedule appointments as they are received, regardless of the priority category of the appointment requests.

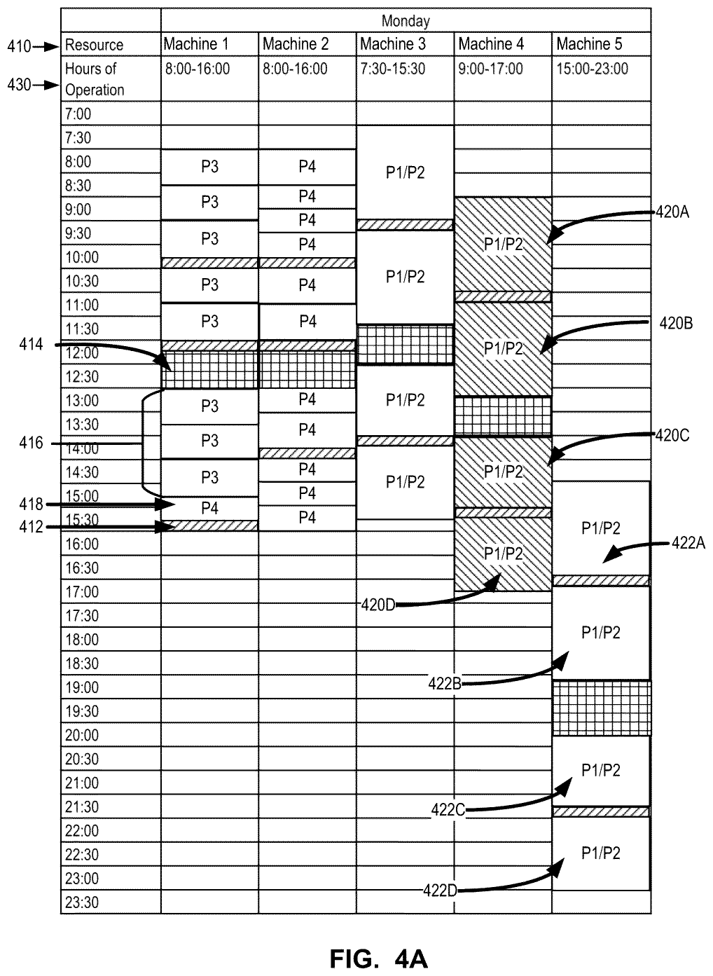

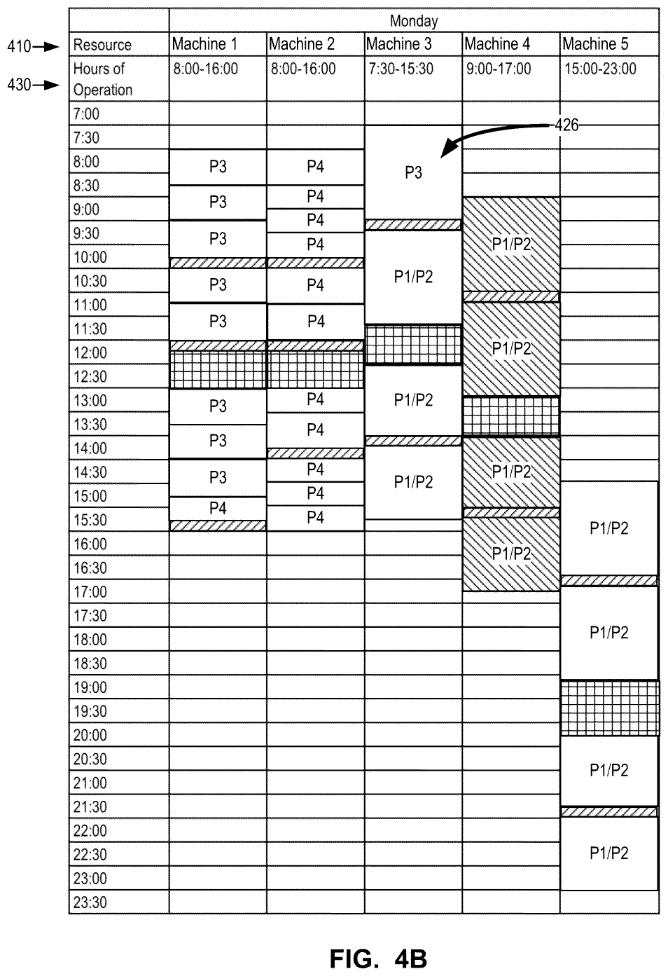

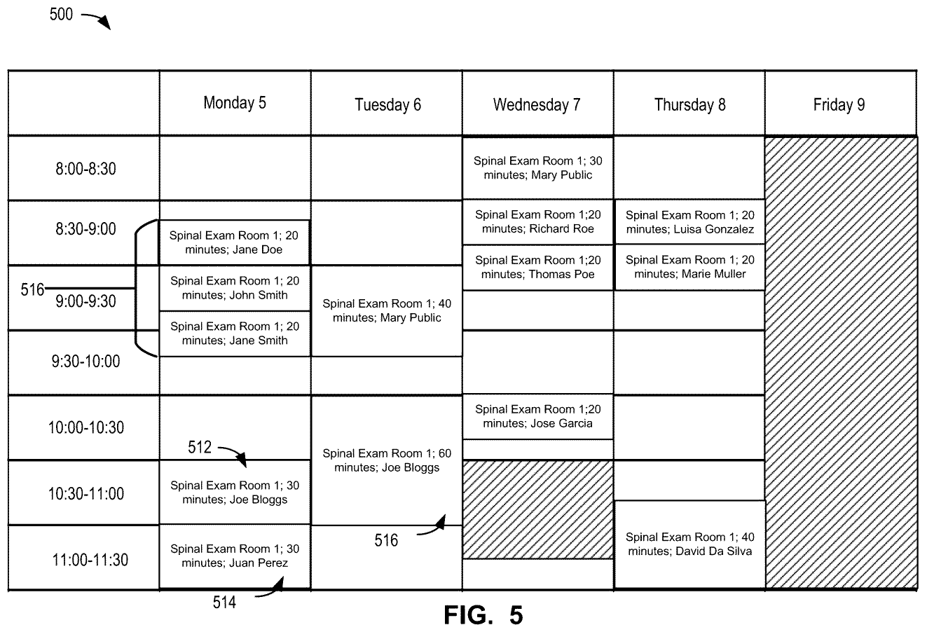

To maximize resource utilization, the scheduling system 202 can preferentially schedule similar appointment requests (e.g., appointments of the same type, appointments having similar attributes) consecutively, as “blocks”. Scheduling appointments which require similar equipment or machines consecutively can minimize set-up time and downtime, and in some cases, minimize personnel downtime. When determining an appointment time for an appointment request, the processor 212 can preferentially search the provider schedule for existing blocks of similar appointments. In embodiments where appointment requests belonging to some priority categories are processed in batches, the processor 212 can preferentially schedule appointment requests belonging to these priority categories as blocks. Referring briefly to FIG. 4A, which shows an example appointment schedule for a provider, as shown, appointment block 416 includes multiple appointments of the same priority category. Similarly, referring briefly to FIG. 5 which shows an example appointment schedule for one machine, appointment block 516 is comprised of multiple appointments of the same type.

To maximize resource utilization, within a time block, the scheduling system 102 can additionally preferentially schedule a greater number of appointments. For example, the processor 212 may prioritize scheduling two 20-minute appointments over a 40-minute appointment. As shown in FIG. 5, assuming all appointments are generally similar, 30-minute appointments 512 and 514 are prioritized over 60-minute appointment 516.

To maximize resource utilization, the scheduling system 202 can additionally minimize down-time during appointment time slots. For example, if a 40-minute time slot is available in a schedule, the processor 212 may preferentially assign the time slot to a 35-minute appointment over a 30-minute appointment.

In some embodiments, the processor 212 is operable to identify a user profile associated with an appointment request and determine appointment preferences based on the user profile. For example, each user of the scheduling system 102 can be associated with a user profile that stores preferences relating to appointments and the processor 212 may identify that an appointment request received is for an individual whose user profile indicates preferences regarding scheduling of appointments. The appointment preferences can include any preferences that affect scheduling of an appointment. Appointment preferences can include for example, preferences relating to appointment times and contraindications relating to equipment or treatments used during an appointment affecting the equipment, machine and/or resources required for an appointment. For example, an individual may have a medical condition that prevents the individual from being examined using a particular machine. The processor 212 can determine appointment times based in part on appointment preferences. For example, the processor 212 can determine that an appointment request received is associated with an individual who has indicated a preference for afternoon appointments and accordingly preferentially assign an appointment time in the afternoon for the individual. In some embodiments, appointment preferences stored in user profiles are assigned a relative priority relative to the factors described above. In some embodiments, depending on the implementation of the scheduling system 102 and on the provider, in determining appointment times for appointment requests, the processor 212 can prioritize fulfilling appointment preferences over determining appointment times within the corresponding wait time targets of the appointment requests. For example, the processor 212 can preferentially assign a time slot to an appointment request associated with a waiting time that is greater than the wait time target of the appointment request if the time slot meets the appointment preferences of the individual associated with the appointment request.

In some embodiments, the processor 212 is operable to determine user attributes based on the user profile and determine appointment times based in part on the user attributes. Similar to the appointment preferences, user attributes can be stored in the user profile. User attributes can be any characteristic of an individual that constrain the individual's ability to attend an appointment. For example, user attributes can include, but are not limited to, the age of the individual, whether the individual has a disability, the type of disability and whether the disability affects scheduling of an appointment and a medical condition of the individual. For example, the processor 212 can determine that an individual's user profile indicates that the individual has a disability that affects mobility and that the individual requires additional time when attending appointments. The processor 212 accordingly allocates a longer time window for the appointment relative to the standard length of the appointment or searches for a longer time slot in the provider schedule. As another example, the processor 212 can determine, based on an individual's user profile that the individual is elderly and is likely to have mobility challenges. The processor 212 accordingly allocates a longer time window for the appointment relative to the standard length of the appointment. The processor 212 can additionally avoid scheduling an appointment in a room that is not accessible to the individual, based on the individual's mobility constraints.

At 318, the processor 212 transmits the appointment time for each appointment to the user device 206 associated with the appointment. The appointment time can be transmitted via any means that allows the individual to accept or decline the appointment. For example, the appointment time can be transmitted via SMS text message, email, smartphone application, automated telephone call, telephone, etc.

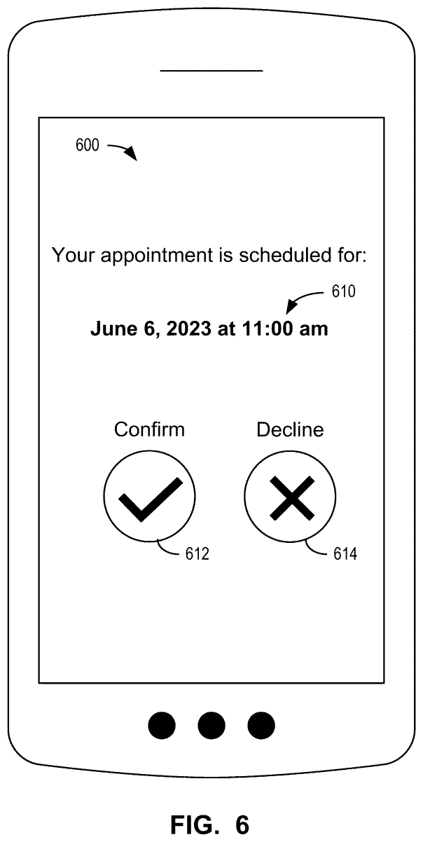

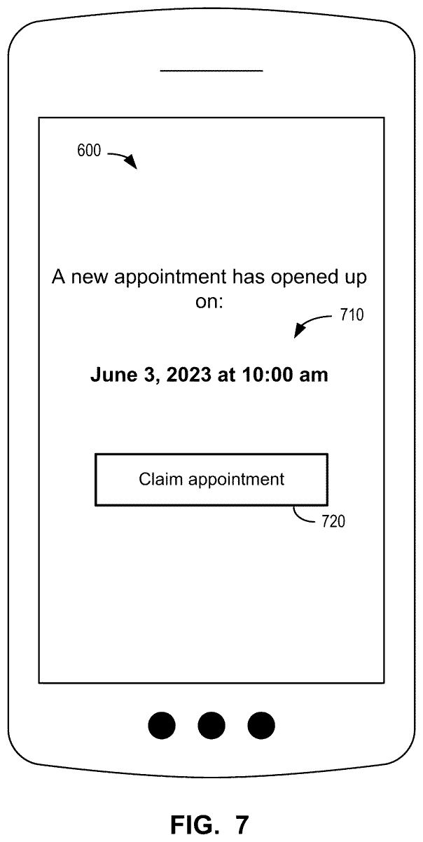

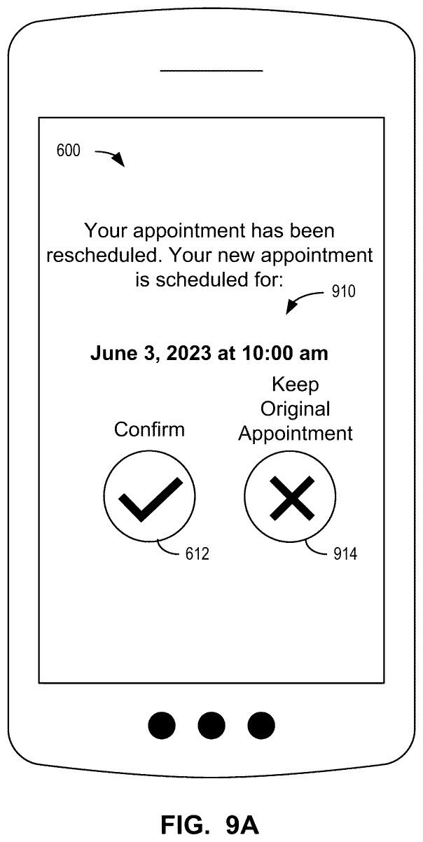

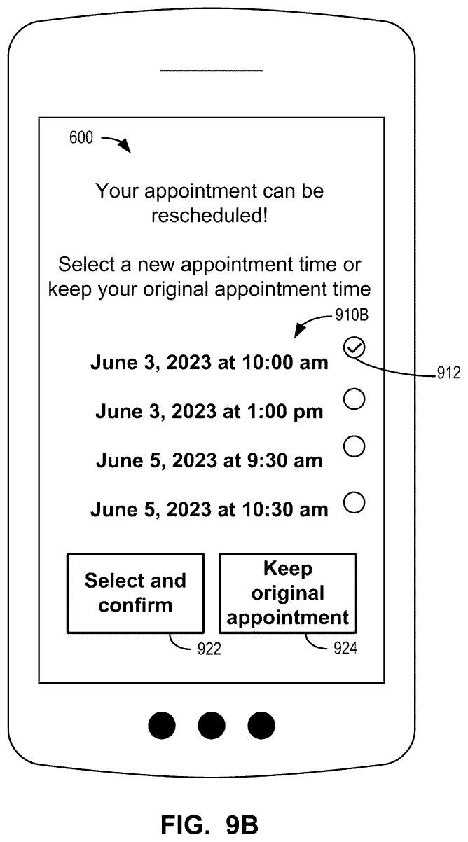

Referring to FIG. 6, shown therein is a screenshot of an example graphical user interface 600 of an appointment time being transmitted. As shown in FIG. 6, the appointment time 610 is transmitted to a smartphone device (i.e., a user device 206) and the user is provided with an option to confirm the appointment time or decline the appointment time using buttons 612 and 614 on the graphical user interface 600. It will be understood that FIG. 6, FIG. 7 and FIGS. 9A-9B show example graphical user interfaces and that notifications and confirmations may be transmitted to user devices 206 using any means that allow the user to provide feedback (e.g., accept/confirm an appointment, decline an appointment, cancel an appointment, reschedule an appointment).

In some embodiments, at 320, the processor 212 temporarily reserves (i.e. “soft books”) the appointment times determined at 314 in the provider schedule. In such embodiments, once the processor 212 transmits an appointment time to a user device, the processor 212 monitors for an appointment confirmation. A shown in FIG. 6 for example, the user can confirm or decline an appointment. When the user confirms or declines the appointment, an appointment confirmation or appointment rejection is transmitted to the scheduling system 102. The processor 212 can monitor for a confirmation (or rejection) for a predetermined time period. If the appointment confirmation (or rejection) is not received within the time period prescribed, the appointment may be removed from the provider schedule and the time slot assigned to one or more other appointment requests. The predetermined time period can vary and can be determined by the provider. For example, the predetermined time period may be 4 hours. Monitoring for an appointment confirmation over a predetermined time period can increase provider efficiency and minimize “no-shows”, as the scheduling system 100 can prioritize individuals who have confirmed to their appointment time.

Referring now to FIG. 3B, there is shown a flowchart of an example method 300B for scheduling appointments with a provider which may be implemented by the scheduling system 102 described herein. Method 300B is substantially similar to method 300A. However, method 300B additionally involves the scheduling system 202 being configured to fill cancelled appointments by reassigning time slots associated with cancelled appointments to other appointments. Automatically reassigning time slots can increase provider efficiency and minimize downtime.

As shown, at 322 the processor 212 receives a cancellation. The cancellation can be received for example, from a user device 206.

At 324, the processor 212 reassigns the time slot originally assigned to the cancelled appointment to another appointment. The cancelled appointment time slots can be filled from a waitlist. For example, the processor 212 can continuously, or at predetermined intervals of time, analyze the provider schedule to determine if one or more scheduled appointments exceed their corresponding wait time target. Appointments associated with a waiting time that exceeds their corresponding wait time target (i.e., appointments scheduled on a date occurring after the wait time target) or exceeding their corresponding wait time target by more than a predetermined threshold may be placed on waitlist(s), which may be ranked. The waitlists may be ranked based on one or more of the factors, such as, for example, the appointment scores of the appointment requests, the waiting time associated with the appointment request, the excess wait time over the wait time target of the appointment request or any other suitable metric. In some embodiments, each waitlist generated by the processor 212 comprises of similar appointments (e.g., appointments having the same type, appointments having similar appointment attributes) and can correspond to a priority category. The processor 212 can reassign the time slot to an appointment request on a corresponding waitlist. If the time slot cannot be filled from a waitlist, for example, if all of the appointments on the waitlist are of a longer duration than the time slot, the timeslot may not be reassigned at 324 and the timeslot may instead be assigned according to the methodology used at 316.

Referring now to FIG. 3C, there is shown a flowchart of an example method 300C for scheduling appointments with a provider which may be implemented by the scheduling system 102 described herein. Method 300C is substantially similar to method 300A. However, method 300C additionally involves proactively rescheduling appointments. Method 300C may be performed in combination with method 300B.

As shown, at 326, the scheduling system 202 proactively reschedules appointments which have been confirmed. For example, in some cases, a time slot previously assigned to an appointment may no longer be available due to for example, unexpected staff shortages or equipment maintenance. In such cases, the processor 212 can reschedule appointments originally scheduled during time slots which are no longer available, using the methodology described at 314. Referring again to FIG. 4A, due to an unforeseen event, the time slot assigned to appointments 420A, 420B, 420C and 420D are no longer available and are consequently rescheduled to time slots 422A, 422B, 422C and 422D.

The processor 212 can additionally continuously, or at predetermined intervals of time monitor the appointment schedules to determine if the appointment schedules can be modified to improve resource utilization and/or to minimize wait times. For example, the processor 212 can determine that assigning the time slot originally assigned to a first appointment request to a second appointment request and rescheduling the first appointment leads to an overall reduction in waiting time, an increase in the number of appointments scheduled within their associated wait time targets and/or an improvement in resource utilization. The appointment requests may be selected by the processor 212 based on their respective appointment scores. For example, a time slot may only be reassigned to an appointment request associated with an equal or higher appointment score than the appointment request originally scheduled in that time slot. As another example, amongst the appointment requests which would lead to an overall reduction in waiting time, the processor 212 can select the appointment request associated with the highest appointment score.

The processor 212 can then reassign the time slot originally assigned to the first appointment request to the second appointment request, determine a new appointment time for the first appointment request and notify the first and second individuals associated with the appointment requests of the change. The new appointment time for the first appointment request may be later than the original appointment time. In some embodiments, prior to determining a new appointment time for the first appointment request, the first appointment request is assigned additional priority points to indicate the increased priority of the first appointment request and the appointment score of the first appointment request is recalculated. When determining a new appointment time, the processor 212 accordingly prioritizes the first appointment request over other appointment requests having a lower appointment score.

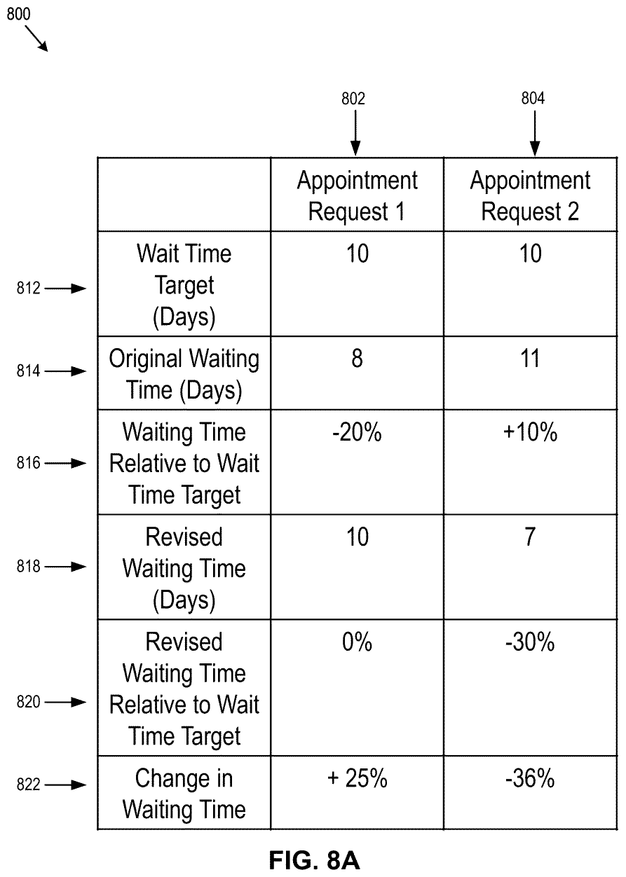

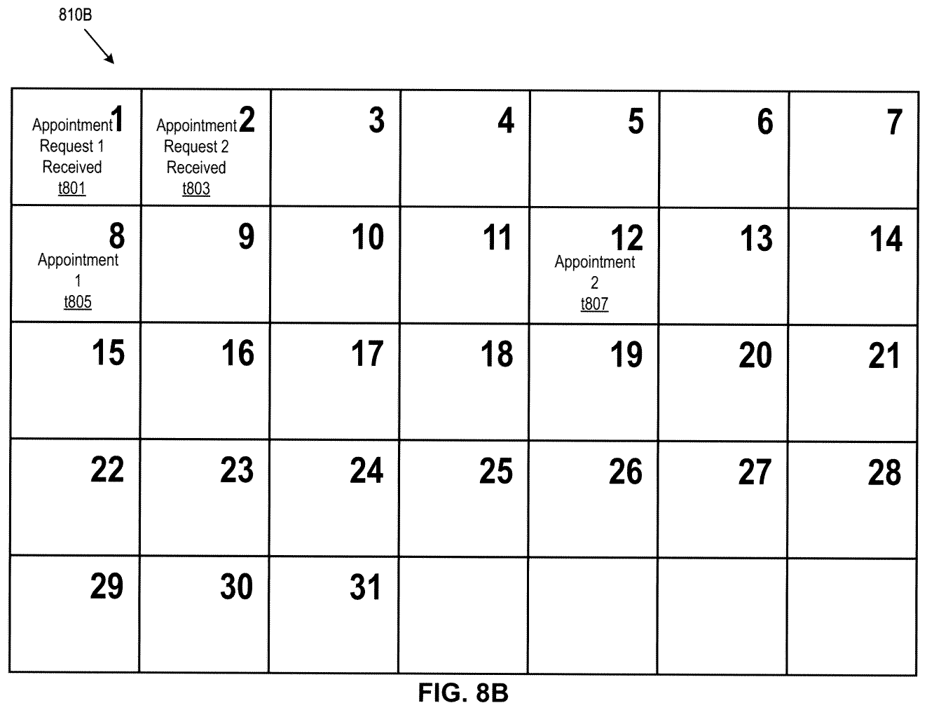

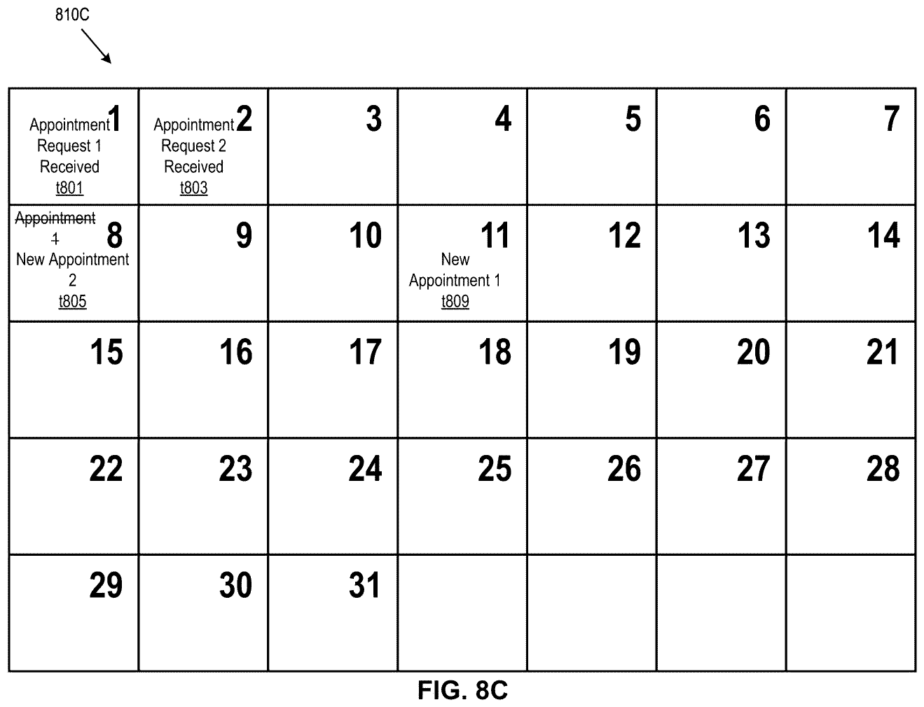

Reference is now simultaneously made to FIG. 8A, which shows a table 800 showing waiting times associated with a first appointment request 802 and a second appointment request 804 and FIGS. 8B-8C, which show calendars 810B, 810C showing the first and second appointment requests. As shown in FIG. 8A, each of the first appointment request 802 and the second appointment requests 804 are associated with a wait time target 812 of 10 days. As shown, the first appointment request 802, received at time t801 is originally scheduled at time t805, corresponding to an original waiting time 814 of 8 days and to a waiting time relative to the wait time target 816 of −2 days, or −20%. The second appointment request 804, received at time t803 is originally scheduled at time t807, corresponding to an original waiting time 812 of 11 days and a waiting time relative to the wait time target 816 of +1 days, or 10%. In this illustrated example, when the appointment time t805 originally assigned to the first appointment request is reassigned to the second appointment request, and the first appointment request is rescheduled at a later date t809, the revised waiting time 818 associated with the first appointment increases to 10 days, corresponding to a revised waiting time relative to the wait time target 820 of 0 days or 0% and the revised waiting time associated with the second appointment decreases to 7 days, corresponding to a revised waiting time relative to the wait time target 820 of −3 days, or −30%. While rescheduling the first appointment leads to a +25% change in waiting time 822, reassigning the time slot assigned to the first appointment request 802 to the second appointment request 804 leads to a −36% change in waiting time 822, reducing the total waiting time by 11% (i.e., 25%+−36%). As shown, the processor 212 may automatically reassign or recommend reassigning the first appointment time slot to the second appointment request, even if the new waiting time for the first appointment request increases and transmit the revised appointment times to the user devices 206 associated with the first appointment request 802 and the second appointment request 804. In cases where the processor 212 recommends reassigning the first appointment time slot, the processor 212 can transmit the revised appointment time to a user device 206 associated with the second appointment request and monitor for a confirmation (or rejection) of the revised appointment time.

In some embodiments, the processor reassigns time slots only if the first appointment request 802 and the second appointment request 804 fulfill eligibility criteria. In some embodiments, the processor 212 only reassigns time slot t805 to the second appointment request 804 if the original waiting time relative to the wait time target 816 of the second appointment request exceeds a predetermined eligibility threshold, if the change in waiting time 822 exceeds a predetermined threshold and/or if the overall change in waiting time exceeds a predetermined threshold. For example, an appointment associated with an appointment request may only be eligible for being rescheduled at an earlier date if the original waiting time exceeds the predetermined eligibility threshold. As another example, an appointment associated with an appointment request may only be eligible for being rescheduled at an earlier date if the proposed new appointment time would lead to a reduction in waiting time that exceeds a predetermined threshold. As another example, an appointment associated with a second appointment request may only be eligible for being rescheduled at an earlier date if reassigning a time slot originally allocated to a first appointment request to the second appointment request and rescheduling the first appointment request to a later date would lead to an overall reduction in waiting time that exceeds a predetermined threshold.

The processor 212 may also only reassign time slot t805 to the second appointment request 802 if the original waiting time relative to the wait time target 816 of the first appointment falls under a predetermined threshold and/or if the change in waiting time 822 associated with the first appointment request 802 falls under a predetermined threshold. For example, the processor 212 may determine that an appointment associated with a first appointment request should not be rescheduled (i.e., the time slot associated with the appointment request should not be reassigned) due to the waiting time relative to the wait time target of the appointment request exceeding a predetermined threshold. As another example, the processor 212 may determine that an appointment associated with a first appointment request should not be rescheduled because the revised appointment time for the first appointment request would lead to a change in waiting time that exceeds a predetermined threshold. This may occur, for example, when all time slots available would lead to an increase in waiting time that exceeds the predetermined threshold and accordingly the first appointment request cannot be rescheduled without causing a change in waiting time that exceeds the predetermined threshold.

For ease of illustration, only two appointment requests are shown in FIGS. 8A-8C. However, it will be understood that the process illustrated in FIGS. 8A-8C can be applied to more than two appointment requests.

In some embodiments, the processor 212 can determine that modifying the appointment time of at least one appointment request causes a reduction in overall waiting time. In such an example, the processor 212 determines revised appointment times for at least one of the appointment request(s). For example, the processor 212 can determine that an appointment can be rescheduled at an earlier date or time, for example, in a vacant time slot, causing the combined wait time of all appointments scheduled relative to their respective wait time target to decrease. In some cases, the processor 212 can reschedule a first appointment at an earlier date or time, and allocate the original appointment time of the first appointment to a second appointment request associated with an appointment originally scheduled at a later date or time. The processor 212 can select appointments to be rescheduled in part based on the appointment scores of the appointment requests. When determining revised appointment times for appointment requests, the processor 212 can apply the same methodology than the methodology originally used at 314 to determine the appointment times. The processor 212 can use the same eligibility criteria as described above with reference to FIGS. 8A-8C for identifying appointments to be rescheduled.

In some embodiments, the processor 212 can determine that the waiting time associated with an appointment request exceeds the wait time target of the appointment request by more than an allowable range. The range may be a threshold (e.g., 10%, 30%, 40%, etc.) and may be fixed, or may vary depending on the provider, the priority category and/or the appointment type. The processor 212 can then determine a revised appointment time for the appointment request such that the appointment is scheduled within the wait time target, within an allowable range of the wait time target or at a minimum, reduces the waiting time of the appointment request.

In embodiments where the scheduling system 202 can proactively reschedule appointments or fill cancelled appointment slots, the processor 212 transmits a revised appointment time to the user device 206 associated with the appointment being rescheduled. As shown in FIG. 9A, which shows a screenshot of the GUI 600 showing an example revised appointment notification, a revised appointment time 910A may be transmitted to the user device 206. In some cases, the user is provided with the option of confirming the revised appointment time or keeping the original appointment time, using buttons 612 and 914, respectively. In some embodiments, as shown in FIG. 9B, which shows another screenshot of the GUI 600 showing an example revised appointment notification, a list of revised appointment times 910B is transmitted to the user device 206. A revised appointment time may be selected, for example, using a checkbox 912 and a confirmation button 922. Though FIG. 9B shows a combination of checkboxes and buttons, any other means for selecting a revised appointment time from a list may be used.

In embodiments where the scheduling system 202 can fill cancelled appointments, the processor 212 can transmit the revised appointment time to the user device 206 associated with the first individual on the waiting list and monitor for an appointment confirmation. If a confirmation is not received within the allocated time period, the processor 212 can reassign the timeslot to the second individual on the waiting list. This process can be repeated until a confirmation is received. Alternatively, the process can be repeated until the timeslot has been unsuccessfully assigned to a predetermined number of individuals, or over a predetermined period of time. For example, after unsuccessfully reassigning the timeslot to the first five individuals on the waiting list, the processor 212 can cease attempting to reassign the timeslot to subsequent individuals on the waiting list. Alternatively, or in addition thereto, as shown in FIG. 7, which shows another screenshot of the GUI 600, if a confirmation is not received within the allocated time period, the processor 212 can transmit to all the user devices 206 associated with the individuals on the waiting list a notification that the timeslot associated with the cancelled appointment 710 is available. The individual associated with the first user device 206 to claim the appointment time may be assigned the time slot. For example, the appointment time slot may be claimed via button 720.

Referring simultaneously to FIGS. 4A-4B again, which show example provider schedules, as shown, each resource can be associated with different operating hours 430. The provider schedule can include time slots that which are not available for booking (412, 414). When determining appointment times, the processor 212 may not schedule appointments outside the hours of operation 430 of the resource or during time windows that are not available for booking (shown using hashed fill patterns). Each resource 410 can correspond to a machine, an equipment or a room required for the appointment. As shown, appointments can be scheduled in blocks of the same priority category (e.g., block 416). As shown however, appointment 418, a priority 4 category appointment is scheduled in the same block as block 416 of priority 3 category appointments. Appointment 418 may correspond to, for example, a rescheduled appointment or an appointment previously cancelled by the provider, or may be an appointment as originally scheduled according to the methodology used at 316.

As shown in FIG. 4B, appointment 426 is a priority 3 category appointment that is scheduled in a time slot originally assigned to priority 1 or priority 2 category appointments. Appointment 426 may correspond to an appointment that has been rescheduled multiple times by the provider, causing the appointment score of the appointment request to be comparable to appointment requests associated with high priority categories.

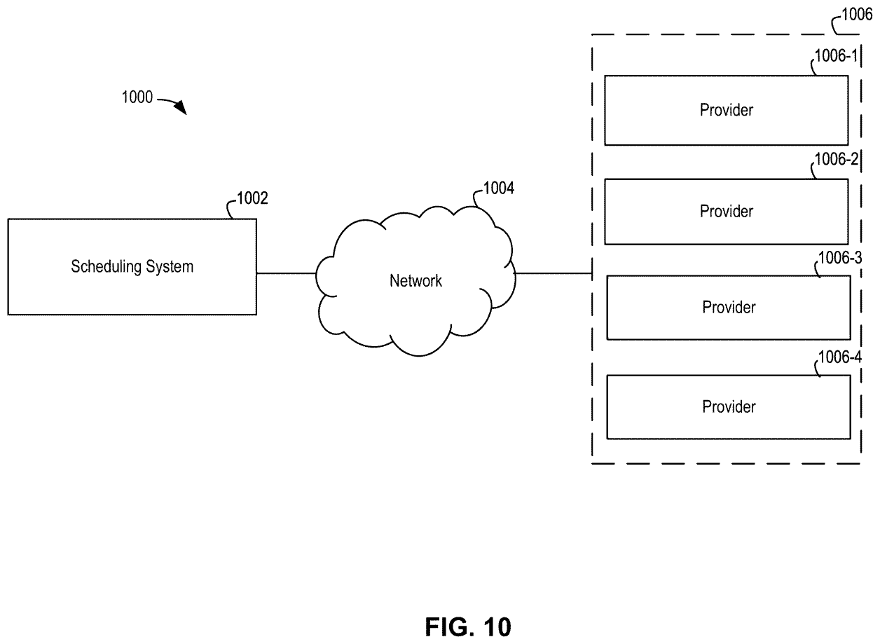

Referring now to FIG. 10, there is shown a block diagram 1000 of a scheduling system 1002 in communication with several providers 1006. The scheduling system 1002 can be substantially similar to the scheduling system 102 and each of the providers 1006 can be similar to the provider 106. The scheduling system 1002 however can schedule appointments across various providers 1006, for example, providers offering the same types of appointments (e.g., hospitals belonging to the same hospital network, hospitals and clinics belonging to the same healthcare provider network, etc.). Scheduling appointments with multiple providers 706 can help balance the appointment load across multiple providers, can increase efficiency and can decrease the overall wait time.

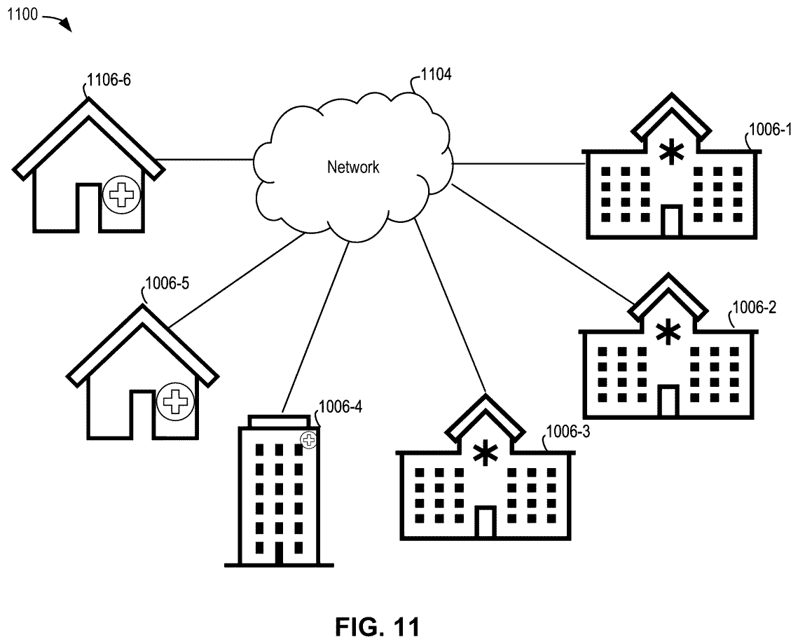

Referring briefly to FIG. 11, there is shown a block diagram 1100 of an example network of providers 1106 in communication with a network 1104. As shown the providers can be a combination of hospitals 1106-1, 1106-2, 1106-3 and clinics 1106-4, 1106-5, 1106-6. The providers 1106 can correspond to the providers 1006. For example, provider 1106-1 may be a research hospital and providers 1106-2 and 1106-3, local hospitals.

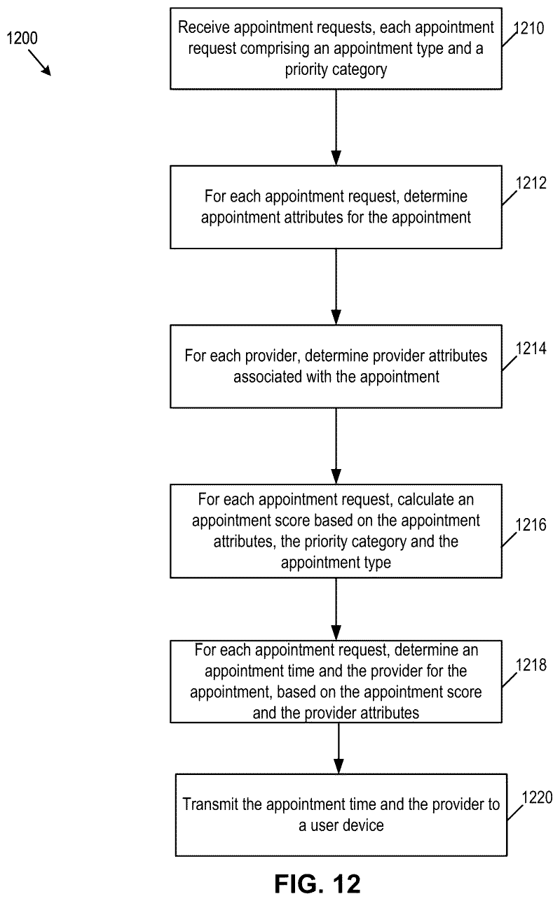

Referring now to FIG. 12, there is shown a flowchart of a method 1200 of scheduling appointments with a provider within a network of multiple providers, according to an example embodiment. Method 1200 may be substantially similar to method 300 (300A, 300B, 300C) and may be performed by a processor such as processor 212. However, method 1200 can additionally involve determining provider preferences when identifying a user profile associated with an individual, determining provider attributes for each of the providers within the network and determining a provider for each appointment request.

At 1210, similar to 310, the processor 212 receives appointment requests and each request can include an appointment type and a priority category for the appointment, the priority category being associated with a wait time target.

At 1212, similar to 312, the processor 212 determines appointment attributes for each appointment request.

At 1214, the processor 212 determines provider attributes for the appointment associated with the appointment request. Unlike method 300, the processor in method 1200 additionally determines provider attributes for each of the appointment requests received.

At 1216, similar to 314, the processor 212 calculates an appointment score for each appointment received. The appointment score can be based on the appointment attributes, the priority category and the appointment type.

At 1218, for each appointment request, the processor 212 determines an appointment time and a provider for the appointment. The determination of an appointment time and the provider can be based on the appointment score and the provider attributes. In embodiments where the processor 212 determines user preferences prior to the processor 212 scheduling appointments, the processor 212 can identify preferences relating to an appointment provider. For example, an individual may have a preference for a specific provider. In such cases, the processor 212 preferentially schedules an appointment with the preferred provider. In some embodiments, the provider attributes can include a ranking of providers, for example, an appointment type or a priority category. In such embodiments, the processor 212 can determine appointment times and providers based in part on the ranking.

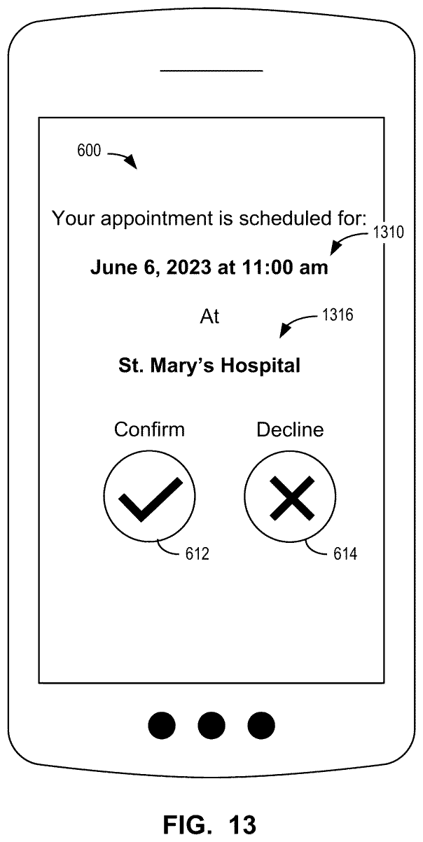

At 1220, similar to 318, the processor 212 transmits the appointment times and the associated provider to the user devices. Referring briefly to FIG. 13, which shows a screenshot of GUI 600 showing an appointment confirmation, the notification includes the appointment time 1310 and the provider 1316 with which the appointment is scheduled. Similar to screenshot of FIG. 6, the individual can confirm or decline the appointment using buttons 612 and 614 on the GUI.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

### Items:

In one item, a system for scheduling appointments with a provider is disclosed herein. The system comprises: a database for storing provider attributes; a processor in communication with the database, the processor operable to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment and a plurality of provider attributes associated with the appointment, based at least on the appointment request; calculate an appointment score based on the priority category, the appointment type and the one or more appointment attributes relating to the appointment; determine an appointment time based on the appointment score calculated and the plurality of provider attributes; and transmit the appointment time to a user device associated with the appointment request, wherein determining the appointment time comprises maximizing a number of appointment requests having appointment times within the corresponding wait time targets.

In another item, the processor is further operable to: determine the appointment time based on one or more of the following factors: the priority category of the appointment request, the appointment type of the appointment request, an appointment receive date of the appointment request.

In one item, each of the factors, the appointment score and the provider attributes are ranked and the processor is operable to determine the appointment time according to the ranking.

In one item, the processor is operable to search a provider schedule of the provider to determine the appointment time for each appointment request.

In one item, the processor is further operable to: determine that one or more appointment times exceed the wait time target of a corresponding one or more appointment requests; generate one or more waitlist comprising the corresponding one or more appointment requests; receive an appointment cancellation request associated with an appointment; and in response to receiving the appointment cancellation request, assigning the appointment time of the appointment to an appointment request selected from one of the one or more waitlist so that the appointment time for the appointment request is within the corresponding wait time target.

In one item, each of the one or more waitlist is a ranked waitlist according to one of: the appointment score of each of the one or more appointment request and a corresponding wait time of each of the one or more appointment request.

In one item, each of the one or more waitlist is associated with one of an appointment type or appointment attributes.

In one item, the appointment type of the appointment request selected and the appointment type of the appointment associated with the appointment cancellation request are of a same type.

In one item, determining the appointment time comprises determining the appointment time for two or more appointment requests at a predetermined time interval.

In another item, determining the appointment time comprises assigning consecutive appointment times to two or more appointment requests associated with a same appointment type.

In another item, determining the appointment time further comprises maximizing a number of appointments within a predefined time window.

In one item, determining the appointment time further comprises minimizing an unused time of a predetermined time slot.

In another item, determining the appointment is based on a relative importance of the appointment score calculated and each of the provider attributes.

In one item, for each of the appointment requests, the processor is operable to: monitor for an appointment confirmation from the user device in response to the appointment time transmitted to the user device; and if the appointment confirmation is not received within a predetermined time period, assign the appointment time to one or more other appointment requests.

In one item, the processor is further operable to: determine that assigning the appointment time of a first appointment request to a second appointment request causes a reduction in a combined wait time; and reassign the appointment time of the first appointment request to the second appointment request.

In one item, the second appointment request is selected based on the appointment score of each of the first appointment request and the second appointment request.

In one item, the processor is further operable to: assign priority points to the first appointment request; calculate a revised appointment score for the first appointment request based on the priority points; and determine a revised appointment time for the first appointment request, wherein determining the revised appointment time is based on the revised appointment score of the first appointment request and the provider attributes.

In another item, the processor is further operable to: determine that the appointment time of associated with an appointment request exceeds the wait time target of the appointment request by a threshold wait time; and in response to determining that the appointment time exceeds the wait time target, determine a revised appointment time for the appointment request, wherein the revised appointment time reduces a wait time associated with the appointment request.

In one item, the processor is further operable to: determine that modifying the appointment time of one or more appointment requests causes a reduction in a combined wait time; determining a revised appointment time for one or more of the one or more appointment requests, wherein the revised appointment time reduces the combined wait time.

In one item, for each of the appointment requests, the processor is further operable to: identify a user profile associated with the appointment request; determine appointment preferences for the appointment based on the user profile; and determine the appointment time based on the appointment preferences.

In one item, the processor is further operable to: determine one or more user attributes based on the user profile; and determine the appointment time based on the one or more user attributes.

In one item, the one or more attributes comprise one or more of: an age of the individual, a disability status of the individual, a type of disability of the individual and a medical condition of the individual.

In one item, the one or more appointment attributes comprise one or more of: a patient status, a referral order receive date, and a machine required for the appointment.

In one item, the plurality of provider attributes comprise two or more of: operating times of the provider, predefined times for the appointment type, predefined times for priority categories, predefined times for the appointment attributes, preferences relating to a machine required for the appointment, personnel required for the appointment, a duration of the appointment based on the machine required for the appointment, policies relating to the appointment type and a relative importance of the provider attributes.

In one item, the priority category for the appointment is one of a first priority category associated with a first wait time target, a second priority category associate with a second wait time target, a third priority category associated with a third wait time target and a fourth priority category associated with a fourth wait time target, wherein the fourth wait time target corresponds to a time period longer than the third wait time target, the third wait time target corresponds to a time period longer than the second wait time target, and the second wait time target corresponds to a time period longer than the first wait time target.

In another item, the priority category for the appointment is one of a first priority category associated with a wait time target of 24 hours, a second priority category associate with a wait time target of 48 hours, a third priority category associated with a wait time target of 10 days and a fourth priority category associated with a wait time target of 28 days.

In another item, the priority category for the appointment is one of two or more priority categories.

In one item, each of the two or more priority categories is associated with a different wait time target.

In one item, a method for scheduling appointments with a provider is disclosed. The method comprises operating a processor to receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment and a plurality of provider attributes associated with the appointment, based at least on the appointment request; calculate an appointment score based on the priority category, the appointment type and the one or more appointment attributes relating to the appointment; determine an appointment time based on the appointment score calculated and the plurality of provider attributes; and transmit the appointment time to a user device associated with the appointment request, wherein determining the appointment time comprises maximizing a number of appointment requests having appointment times within the corresponding wait time targets.

In one item, the method comprises operating the processor to: determine the appointment time based on one or more of the following factors: the priority category of the appointment request, the appointment type of the appointment request, an appointment receive date of the appointment request.

In one item, each of the factors, the appointment score and the provider attributes are ranked and wherein the processor is operable to determine the appointment time according to the ranking.

In one item, the method further comprises operating the processor to search a provider schedule of the provider to determine the appointment time for each appointment request.

In another item, the method further comprises operating the processor to: determine that one or more appointment times exceed the wait time target of a corresponding one or more appointment requests; generate one or more waitlist comprising the corresponding one or more appointment requests; receive an appointment cancellation request associated with an appointment; and in response to receiving the appointment cancellation request, assigning the appointment time of the appointment to an appointment request selected from one of the one or more waitlist so that the appointment time for the appointment request is within the corresponding wait time target.

In one item, each of the one or more waitlist is a ranked waitlist according to one of: the appointment score of each of the one or more appointment request and a corresponding wait time of each of the one or more appointment request.

In another item, each of the one or more waitlist is associated with one of an appointment type or appointment attributes.

In one item, the appointment type of the appointment request selected and the appointment type of the appointment associated with the appointment cancellation request are of a same type.

In one item, determining the appointment time comprises operating the processor to determine the appointment time for two or more appointment requests at a predetermined time interval.

In another item, determining the appointment time comprises operating the processor to assign consecutive appointment times to two or more appointment requests associated with a same appointment type.

In another item, determining the appointment time further comprises maximizing a number of appointments within a predefined time window.

In another item, determining the appointment time further comprises minimizing an unused time of a predetermined time slot.

In another item, determining the appointment is based on a relative importance of the appointment score calculated and each of the provider attributes.

In one item, for each of the appointment requests, the processor is operable to: monitor for an appointment confirmation from the user device in response to the appointment time transmitted to the user device; and if the appointment confirmation is not received within a predetermined time period, assign the appointment time to one or more other appointment requests.

In one item, the method further comprises operating the processor to: determine that assigning the appointment time of a first appointment request to a second appointment request causes a reduction in a combined wait time; and reassign the appointment time of the first appointment request to the second appointment request.

In one item, the second appointment request is selected based on the appointment score of each of the first appointment request and the second appointment request.

In one item, the method further comprises operating the processor to: assign priority points to the first appointment request; calculate a revised appointment score for the first appointment request based on the priority points; determine a revised appointment time for the first appointment request; and determine the revised appointment time based on the revised appointment score of the first appointment request and the provider attributes.

In another item, the method further comprises operating the processor to: determine that the appointment time of associated with an appointment request exceeds the wait time target of the appointment request by a threshold wait time; and in response to determining that the appointment time exceeds the wait time target, determine a revised appointment time for the appointment request, wherein the revised appointment time reduces a wait time associated with the appointment request.

In another item, the method further comprises operating the processor to: determine that modifying the appointment time of one or more appointment requests causes a reduction in a combined wait time; determining a revised appointment time for one or more of the one or more appointment requests, wherein the revised appointment time reduces the combined wait time.

In one item, the method further comprises, for each of the appointment requests, operating the processor to: identify a user profile associated with the appointment request; determine appointment preferences for the appointment based on the user profile; and determine the appointment time based on the appointment preferences.

In another item, the method further comprises operating the processor to: determine one or more user attributes based on the user profile; and determine the appointment time based on the one or more user attributes.

In one item, the one or more attributes comprise one or more of: an age of the individual, a disability status of the individual, a type of disability of the individual and a medical condition of the individual.

In one item, the one or more appointment attributes comprise one or more of: a patient status, a referral order receive date, and a machine required for the appointment.

In one item, the plurality of provider attributes comprise two or more of: operating times of the provider, predefined times for the appointment type, predefined times for priority categories, predefined times for the appointment attributes, preferences relating to a machine required for the appointment, personnel required for the appointment, a duration of the appointment based on the machine required for the appointment, policies relating to the appointment type and a relative importance of the provider attributes.

In another item, the priority category for the appointment is one of a first priority category associated with a first wait time target, a second priority category associate with a second wait time target, a third priority category associated with a third wait time target and a fourth priority category associated with a fourth wait time target, wherein the fourth wait time target corresponds to a time period longer than the third wait time target, the third wait time target corresponds to a time period longer than the second wait time target, and the second wait time target corresponds to a time period longer than the first wait time target.

In another item, the priority category for the appointment is one of a first priority category associated with a wait time target of 24 hours, a second priority category associate with a wait time target of 48 hours, a third priority category associated with a wait time target of 10 days and a fourth priority category associated with a wait time target of 28 days.

In another item, the priority category for the appointment is one of two or more priority categories.

In one item, each of the two or more priority categories is associated with a different wait time target.

In another item, a system for scheduling appointments with a provider within a network of two or more providers is disclosed. The system comprises: a database for storing provider attributes associated with each of the providers; a processor in communication with the database, the processor operable to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment; for each of the providers, determine a plurality of provider attributes associated with the appointment based at least on the appointment request; calculate an appointment score based on the priority category, the appointment type and one or more attributes relating to the appointment; determine an appointment time and the provider for the appointment based on the appointment score calculated and the plurality of provider attributes of each of the providers; and transmit the appointment time and the provider to a user device associated with the appointment request, wherein determining the appointment time comprises maximizing a number of appointment times within the wait time target of corresponding appointment requests.

In one item, for each of the appointment request, the processor is further operable to: identify a user profile associated with the appointment request; determine appointment preferences for the appointment based on the user profile, the appointment preferences comprising preferences relating to the two or more providers; and determine the appointment time based on the appointment preferences.

In one item, a method for scheduling appointments with a provider within a network of two or more providers is disclosed. The method comprises operating a processor to: receive a plurality of appointment requests, wherein each appointment request comprises an appointment type and a priority category for the appointment, each priority category associated with a corresponding wait time target; for each appointment request of the plurality of appointment requests, determine one or more appointment attributes relating to the appointment; for each of the providers, determine a plurality of provider attributes associated with the appointment based at least on the appointment request; calculate an appointment score based on the priority category, the appointment type and one or more attributes relating to the appointment; determine an appointment time and the provider for the appointment based on the appointment score calculated and the plurality of provider attributes of each of the providers; and transmit the appointment time and the provider to a user device associated with the appointment request, wherein determining the appointment time comprises maximizing a number of appointment times within the wait time target of corresponding appointment requests.

In one item, the method further comprises, for each of the appointment request, operating the processor to: identify a user profile associated with the appointment request; determine appointment preferences for the appointment based on the user profile, the appointment preferences comprising preferences relating to the two or more providers; and determine the appointment time based on the appointment preferences.

1. A system for optimized appointment scheduling and management with a provider, the system comprising:
a database for storing provider attributes;
a processor in communication with the database, the processor operable to:
receive a plurality of appointment requests, wherein each appointment request comprises an appointment type and a priority category for the appointment, each priority category associated with a corresponding wait time target;
for each appointment request of the plurality of appointment requests,
determine one or more appointment attributes relating to the appointment and a plurality of provider attributes associated with the appointment, based at least on the appointment request;
calculate an appointment score based on the priority category, the appointment type and the one or more appointment attributes relating to the appointment;
determine an appointment time based on the appointment score calculated and the plurality of provider attributes; and
transmit the appointment time to a user device associated with the appointment request,
wherein determining the appointment time comprises maximizing a number of appointment requests having appointment times within the corresponding wait time targets.

2. The system of claim 1, wherein the processor is further operable to:
determine the appointment time based on one or more of the following factors: the priority category of the appointment request, the appointment type of the appointment request, an appointment receive date of the appointment request.

3. The system of claim 2, wherein each of the factors, the appointment score and the provider attributes are ranked and wherein the processor is operable to determine the appointment time according to the ranking.

4. The system of claim 1, wherein the processor is further operable to:
determine that one or more appointment times exceed the wait time target of a corresponding one or more appointment requests;
generate one or more waitlist comprising the corresponding one or more appointment requests;
receive an appointment cancellation request associated with an appointment; and
in response to receiving the appointment cancellation request, assigning the appointment time of the appointment to an appointment request selected from one of the one or more waitlist so that the appointment time for the appointment request is within the corresponding wait time target.

5. The system of claim 4, wherein each of the one or more waitlist is a ranked waitlist according to one of: the appointment score of each of the one or more appointment request and a corresponding wait time of each of the one or more appointment request.

6. The system of claim 1, wherein determining the appointment time comprises determining the appointment time for two or more appointment requests at a predetermined time interval.

7. The system of claim 1, wherein determining the appointment time comprises assigning consecutive appointment times to two or more appointment requests associated with a same appointment type.

8. The system of claim 1, wherein determining the appointment time further comprises maximizing a number of appointments within a predefined time window.

9. The system of claim 1, wherein determining the appointment time further comprises minimizing an unused time of a predetermined time slot.

10. The system of claim 1, wherein determining the appointment is based on a relative importance of the appointment score calculated and each of the provider attributes.

11. The system of claim 1, wherein for each of the appointment requests, the processor is operable to:
monitor for an appointment confirmation from the user device in response to the appointment time transmitted to the user device; and
if the appointment confirmation is not received within a predetermined time period, assign the appointment time to one or more other appointment requests.

12. The system of claim 1, wherein the processor is further operable to:
determine that assigning the appointment time of a first appointment request to a second appointment request causes a reduction in a combined wait time; and
reassign the appointment time of the first appointment request to the second appointment request.

13. The system of claim 1, wherein the processor is further operable to:
determine that the appointment time of associated with an appointment request exceeds the wait time target of the appointment request by a threshold wait time; and
in response to determining that the appointment time exceeds the wait time target, determine a revised appointment time for the appointment request, wherein the revised appointment time reduces a wait time associated with the appointment request.

14. The system of claim 1, wherein the processor is further operable to:
determine that modifying the appointment time of one or more appointment requests causes a reduction in a combined wait time;
determining a revised appointment time for one or more of the one or more appointment requests, wherein the revised appointment time reduces the combined wait time.

15. The system of claim 1, wherein for each of the appointment requests, the processor is further operable to:
identify a user profile associated with the appointment request;
determine appointment preferences for the appointment based on the user profile; and
determine the appointment time based on the appointment preferences.

16. The system of claim 1, wherein the plurality of provider attributes comprise two or more of: operating times of the provider, predefined times for the appointment type, predefined times for priority categories, predefined times for the appointment attributes, preferences relating to a machine required for the appointment, personnel required for the appointment, a duration of the appointment based on the machine required for the appointment, policies relating to the appointment type and a relative importance of the provider attributes.

17. The system of claim 1, wherein the priority category for the appointment is one of a first priority category associated with a first wait time target, a second priority category associate with a second wait time target, a third priority category associated with a third wait time target and a fourth priority category associated with a fourth wait time target, wherein the fourth wait time target corresponds to a time period longer than the third wait time target, the third wait time target corresponds to a time period longer than the second wait time target, and the second wait time target corresponds to a time period longer than the first wait time target.

18. The system of claim 1, wherein the priority category for the appointment is one of a first priority category associated with a wait time target of 24 hours, a second priority category associate with a wait time target of 48 hours, a third priority category associated with a wait time target of 10 days and a fourth priority category associated with a wait time target of 28 days.

19. A system for optimized appointment scheduling and management with a provider within a network of two or more providers, the system comprising:
a database for storing provider attributes associated with each of the providers;
a processor in communication with the database, the processor operable to:
receive a plurality of appointment requests, wherein each appointment request comprises an appointment type and a priority category for the appointment, each priority category associated with a corresponding wait time target;
for each appointment request of the plurality of appointment requests,
determine one or more appointment attributes relating to the appointment;
for each of the providers, determine a plurality of provider attributes associated with the appointment based at least on the appointment request;
calculate an appointment score based on the priority category, the appointment type and one or more attributes relating to the appointment;
determine an appointment time and the provider for the appointment based on the appointment score calculated and the plurality of provider attributes of each of the providers; and
transmit the appointment time and the provider to a user device associated with the appointment request,
wherein determining the appointment time comprises maximizing a number of appointment times within the wait time target of corresponding appointment requests.

20. The system of claim 19, wherein for each of the appointment request, the processor is further operable to:
identify a user profile associated with the appointment request;
determine appointment preferences for the appointment based on the user profile, the appointment preferences comprising preferences relating to the two or more providers; and
determine the appointment time based on the appointment preferences.
